(19) United States
(12) Patent Application Publication
(10) Pub. No.: US 2025/0035458 A1
(43) Pub. Date: Jan. 30, 2025

(54) METHOD AND ELECTRONIC DEVICE FOR VOICE-BASED NAVIGATION

(71) Applicant: SAMSUNG ELECTRONICS CO., LTD., Suwon-si (KR)

(72) Inventors: Lahar GUPTA, New Delhi (IN); Mangi Lal SHARMA, Tehsil Ratangarh (IN)

(73) Assignee: SAMSUNG ELECTRONICS CO., LTD., Suwon-si (KR)

(21) Appl. No.: 18/623,854

(22) Filed: Apr. 1, 2024

Related U.S. Application Data
(63) Continuation of application No. PCT/KR24/03776, filed on Mar. 26, 2024.

(30) Foreign Application Priority Data
Jul. 25, 2023 (IN) 202311050205

(51) Int. Cl. G01C 21/36

(52) U.S. Cl. CPC G01C 21/3629; G01C 21/3644

(57) ABSTRACT

A method performed by an electronic device for voice-based navigation, includes: determining a field of view (FoV) of the user using one or more sensors associated with the electronic device; determining one or more points of interest (PoIs) with respect to the determined FoV of the user, and generating a response for the voice-based navigation based on at least one of the one or more PoIs and the determined FoV of the user.

### CROSS-REFERENCE TO RELATED APPLICATIONS

This application is a by-pass continuation application of International Application No. PCT/KR2024/003776, filed on Mar. 26, 2024, which is based on and claims priority to Indian patent application No. 202311050205, filed on Jul. 25, 2023, in the Indian Intellectual Property Office, the disclosures of which are incorporated by reference herein their entireties.

### BACKGROUND

### 1. Field

The disclosure generally relates to a field of navigation, and more specifically, relates to a method and an electronic device for voice-based navigation in electronic devices.

### 2. Description of Related Art

Voice-based navigation enables users to navigate and control digital electronic devices or applications using spoken commands or instructions. The voice-based navigation may allow the users to interact with the digital electronic devices hands-free, relying solely on the voices of the users to perform various tasks. In the voice-based navigation, the users may provide commands, such as “navigate to a specific location” or “find nearby restaurants”, and the digital electronic devices may process the commands to provide relevant information or perform the requested actions. The voice-based navigation may utilize speech recognition technologies to convert spoken words into text, and then employ, natural language processing (NLP) techniques to understand the intent of the users and extract actionable instructions. Moreover, the voice-based navigation may simplify interactions with the digital electronic devices and may enhance user convenience, particularly in situations where a visual interaction is impractical or unsafe.

While the voice-based navigation may offer convenience and hands-free interaction, the voice-based navigation also has a few problems. One problem is associated with a lack of precision in locating specific destinations while using the voice-based navigation, particularly in scenarios where the user's electronic device is not actively in use or is carried within a pocket. Additionally, another problem is associated with a dependency on visual displays, as illustrated in FIG. 1. In conventional voice-based navigation, earbuds or headphones are primarily utilized for providing audible directions using a built-in global positioning system (GPS) or in conjunction with a smartphone. Moreover, the voice-based navigation heavily relies on visual map displayed on a screen, for example, of a smartphone, necessitating users to continuously monitor the screen for map information and nearby points-of-interest (PoI). This constant visual engagement poses risks in scenarios where the users are moving (e.g., driving), which may potentially lead to accidents or distractions.

Thus, it is desired to address the above-mentioned problems or other shortcomings or at least provide a useful alternative for conventional voice-based navigation.

### SUMMARY

According to an embodiment of the disclosure, a method performed by an electronic device for voice-based navigation may include determining a field of view (FoV) of the user using one or more sensors associated with the electronic device. According to an embodiment of the disclosure, the method performed by the electronic device for voice-based navigation may include determining one or more points of interest (PoIs) with respect to the determined FoV of the user. According to an embodiment of the disclosure, the method performed by the electronic device for voice-based navigation may include generating a response for the voice-based navigation based on at least one of the one or more PoIs and the determined FoV of the user.

According to an embodiment of the disclosure, an electronic device for voice-based navigation, the electronic device may comprise a communicator, a voice-based navigation module, a memory storing at least one instruction; and at least one processor operatively connected to the communicator, the voice-based navigation module, and the memory. According to an embodiment of the disclosure, the voice-based navigation module is configured to determine a field of view (FoV) of the user, using one or more sensors associated with the system. According to an embodiment of the disclosure, the voice-based navigation module is configured to determine one or more points of interest (PoIs) with respect to the determined FoV of the user. According to an embodiment of the disclosure, the voice-based navigation module is configured to generate a response for the voice-based navigation based on at least one of the one or more PoIs and the determined FoV of the user.

According to an embodiment of the disclosure, a system for voice-based navigation, the system may comprise a communicator, a voice-based navigation module, a memory storing at least one instruction; and at least one processor operatively connected to the communicator, the voice-based navigation module, and the memory. According to an embodiment of the disclosure, the voice-based navigation module is configured to determine a field of view (FoV) of the user, using one or more sensors associated with the system. According to an embodiment of the disclosure, the voice-based navigation module is configured to determine one or more points of interest (PoIs) with respect to the determined FoV of the user. According to an embodiment of the disclosure, the voice-based navigation module is configured to generate a response for the voice-based navigation based on at least one of the one or more PoIs and the determined FoV of the user.

### BRIEF DESCRIPTION OF THE DRAWINGS

These and other features, aspects, and advantages of the disclosure will become better understood when the following detailed description is read with reference to the accompanying drawings in which like characters represent like parts throughout the drawings, wherein:

FIG. 1 illustrates a problem scenario in existing voice-based navigation, according to the related art;

FIG. 2 illustrates a block diagram of an electronic device for voice-based navigation, according to an embodiment of the disclosure;

FIG. 3 illustrates a block diagram of a voice-based navigation module associated with the electronic device for the voice-based navigation, according to an embodiment of the disclosure;

FIGS. 4A and 4B illustrate exemplary scenarios to determine a roll angle, a pitch angle, and a yaw angle associated with a head orientation of a user, according to the related art;

FIG. 5 illustrates an exemplary scenario to determine a current field of view (FoV) of the user, according to an embodiment of the disclosure;

FIG. 6 illustrates an exemplary scenario to determine a current location of the user, according to the related art;

FIG. 7 illustrates a decision engine associated with the voice-based navigation module, according to an embodiment of the disclosure;

FIG. 8 illustrates operations for generating a customized digital elevation model (DEM) of the current location of the user, according to an embodiment of the disclosure;

FIG. 9 illustrates operations for determining one or more visible areas and one or more non-visible areas associated with the generated customized DEM in relation to the current location of the user, according to an embodiment of the disclosure;

FIGS. 10A, 10B, and 10C illustrates operations for determining object information, according to an embodiment of the disclosure;

FIG. 11 illustrates a points of interest (PoI) estimation engine associated with the voice-based navigation module, according to an embodiment of the disclosure;

FIG. 12 illustrates operations of a description generator associated with the PoI estimation engine, according to an embodiment of the disclosure;

FIG. 13 illustrates operations for determining a priority of each candidate PoI from a list of candidate PoIs, according to an embodiment of the disclosure;

FIGS. 14A and 14B illustrate exemplary scenarios to determine the priority of each candidate PoI from the list of candidate PoIs, according to an embodiment of the disclosure;

FIG. 15 illustrates a digital assistant module associated with the voice-based navigation module, according to an embodiment of the disclosure;

FIGS. 16A and 16B illustrate operations of a command reception module associated with the digital assistant module, according to an embodiment of the disclosure;

FIG. 17 illustrates operations for generating navigation instruction, according to an embodiment of the disclosure;

FIG. 18 illustrates operations for providing training to a Text-to-Speech (TTS) engine associated with the digital assistant module, according to an embodiment of the disclosure;

FIG. 19 illustrates operations for generating a modified output audio for the voice-based navigation, according to an embodiment of the disclosure;

FIG. 20 illustrates operations for the voice-based navigation, according to an embodiment of the disclosure; and

FIG. 21 illustrates an exemplary comparison between the conventional voice-based navigation method and the disclosed voice-based navigation method, according to an embodiment of the disclosure.

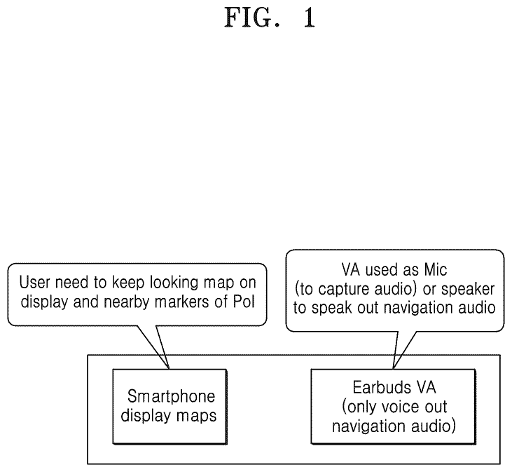

Further, skilled artisans will appreciate those elements in the drawings are illustrated for simplicity and may not have necessarily been drawn to scale. For example, the flow charts illustrate the method in terms of the most prominent operations involved to help to improve understanding of aspects of the disclosure. Furthermore, in terms of the construction of the device, one or more components of the device may have been represented in the drawings by conventional symbols, and the drawings may show only those specific details that are pertinent to understanding the embodiments of the disclosure so as not to obscure the drawings with details that will be readily apparent to those of ordinary skill in the art having the benefit of the description herein.

### DETAILED DESCRIPTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are explanatory of the invention and are not intended to be restrictive thereof.

Reference throughout this specification to “an aspect”, “another aspect” or similar language means that a particular feature, structure, or characteristic described in connection with the embodiment is included in at least one embodiment of the disclosure. Thus, appearances of the phrase “in an embodiment”, “in one embodiment”, “in another embodiment”, and similar language throughout this specification may, but do not necessarily, all refer to the same embodiment.

The terms “comprise”, “comprising”, or any other variations thereof, are intended to cover a non-exclusive inclusion, such that a process or method that comprises a list of operations does not include only those operations but may include other operations not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the one or more embodiments described herein are not necessarily mutually exclusive, as some embodiments can be combined with one or more other embodiments to form new embodiments. The term “or” as used herein, refers to a non-exclusive or unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks that carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the invention. Likewise, the blocks of the embodiments may be physically combined into more complex blocks without departing from the scope of the invention.

The accompanying drawings are used to help easily understand various technical features and it should be understood that the embodiments presented herein are not limited by the accompanying drawings. As such, the present disclosure should be construed to extend to any alterations, equivalents, and substitutes in addition to those which are particularly set out in the accompanying drawings. Although the terms first, second, etc. may be used herein to describe various elements, these elements should not be limited by these terms. These terms are generally only used to distinguish one element from another.

The term “or” is an inclusive term meaning “and/or”. The phrase “associated with,” as well as derivatives thereof, refer to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” refers to any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of A, B, and C” includes any of the following combinations: A, B, C, A and B, A and C, B and C, and A and B and C, and any variations thereof. The expression “at least one of a, b, or c” may indicate only a, only b, only c, both a and b, both a and c, both b and c, all of a, b, and c, or variations thereof. Similarly, the term “set” means one or more. Accordingly, the set of items may be a single item or a collection of two or more items.

The disclosed method may provide a solution to the above-mentioned problems associated with existing voice-based navigation, as discussed throughout the disclosure. The disclosed method may comprise estimating a field of view (FoV) and face rotation information of a user based on at least one of an inertial measurement unit (IMU) sensor and a global positioning system (GPS) sensor. If the GPS sensor is not present in a head-worn device (e.g., earbuds), then the GPS sensor of an electronic device (e.g., smartphone) is used to determine a current position of the user along with the IMU sensor to estimate the FoV of the user. In an embodiment, the disclosed method may obtain map information within and near the FoV. The disclosed method may comprise separating map information from the obtained map information based on a proximity of the user. The disclosed method may further comprise selecting a destination point from the separated map information and determining whether the destination point falls within a proximate FoV. Moreover, the disclosed method may identify one or more objects from the map information with respect to the user's head position (e.g., FoV) in relation to the destination point. The disclosed method may then generate navigation audio instructions, wherein the generated navigation audio instructions are then adjusted based on the user's head position and the one or more identified objects near the destination point. As a result, the user receives precise navigation instructions from the electronic device without relying on a screen of the electronic device, enhancing the user's overall experience.

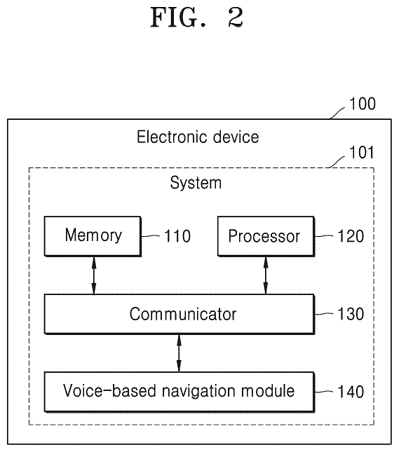

Referring now to the drawings, and more particularly to FIGS. 2 to 21, where similar reference characters denote corresponding features consistently throughout the figures, there are shown preferred embodiments.

FIG. 2 illustrates a block diagram of an electronic device 100 for voice-based navigation, according to an embodiment of the disclosure. Examples of the electronic device 100 may include, but are not limited to, a Personal Digital Assistance (PDA), an Internet of Things (IoT) device, a wearable device, an earphones, an earbuds, etc. In an embodiment, the electronic device 100 comprises a system 101. The system 101 may include a memory 110, a processor 120, a communicator 130, and a voice-based navigation module 140.

In an embodiment, the memory 110 stores instructions to be executed by the processor 120 for voice-based navigation, as discussed throughout the disclosure. The memory 110 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 110 may, in some examples, be considered a non-transitory storage medium. The term “non-transitory” may indicate that the storage medium is not embodied in a carrier wave or a propagated signal. However, the term “non-transitory” should not be interpreted as the memory 110 is non-movable. In some examples, the memory 110 can be configured to store larger amounts of information than the memory. In certain examples, a non-transitory storage medium may store data that can, over time, change (e.g., in Random Access Memory (RAM) or cache). The memory 110 can be an internal storage unit, or it can be an external storage unit of the electronic device 100, a cloud storage, or any other type of external storage.

The processor 120 communicates with the memory 110, the communicator 130, and the voice-based navigation module 140. The processor 120 is configured to execute instructions stored in the memory 110 and to perform various processes for the voice-based navigation, as discussed throughout the disclosure. The processor 120 may include one or a plurality of processors, maybe a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

The communicator 130 is configured for communicating internally between internal hardware components and with external devices (e.g., server) via one or more networks (e.g., Radio technology). The communicator 130 includes an electronic circuit specific to a standard that enables wired and/or wireless communication.

The voice-based navigation module 140 is implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like.

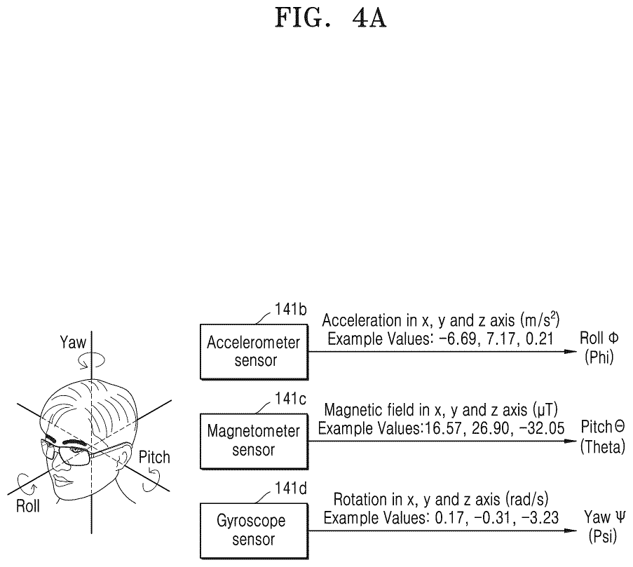

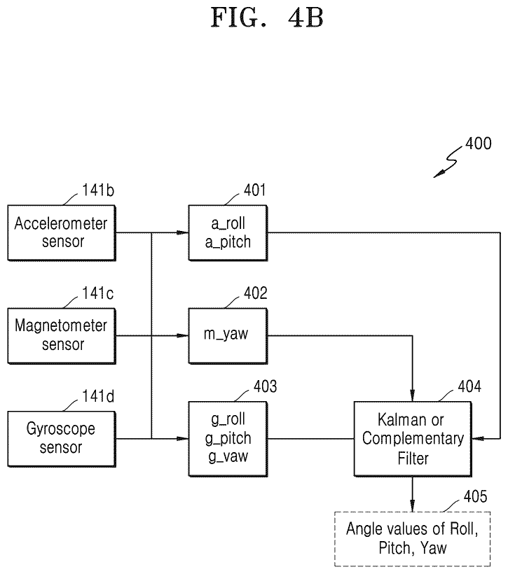

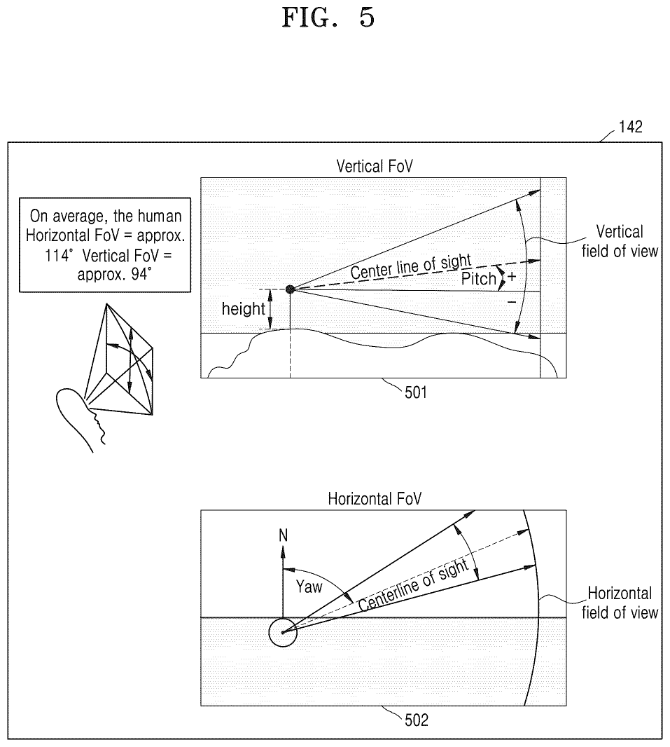

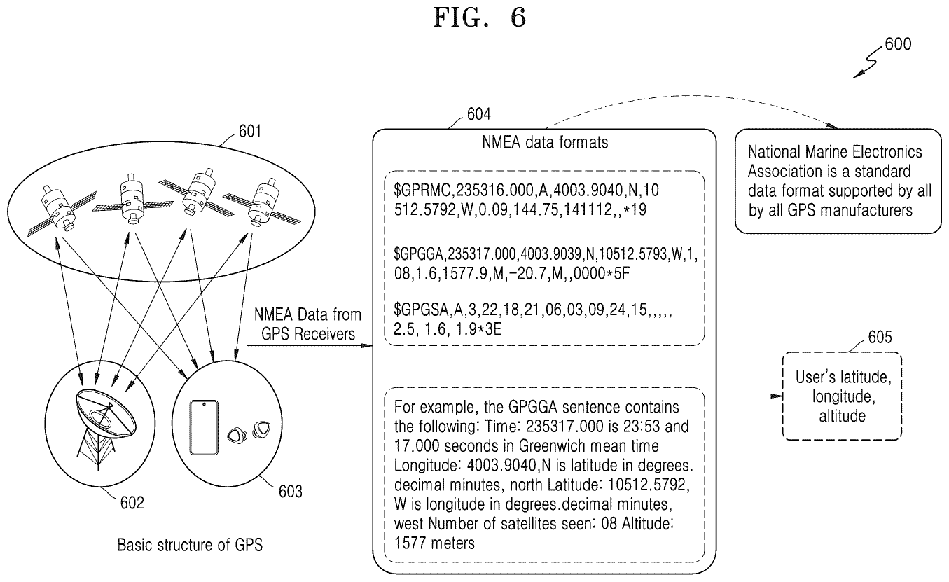

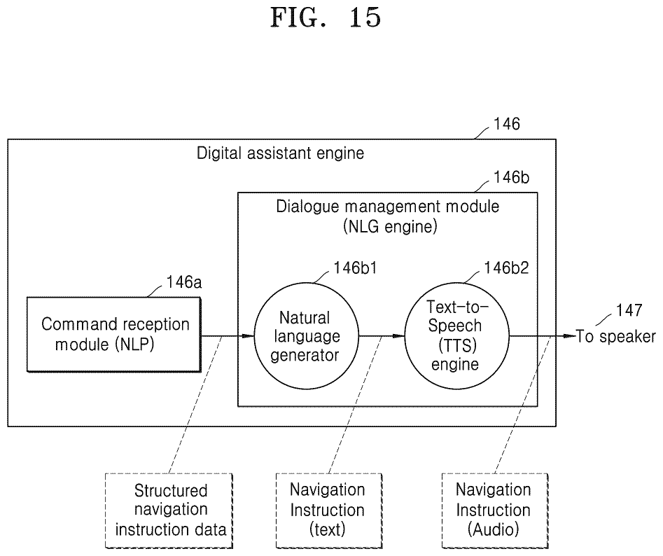

In one or more embodiments, the voice-based navigation module 140 is configured to determine a current field of view (FoV) of the user, using one or more sensors associated with the electronic device 100, as described in conjunction with FIG. 4A, FIG. 4B, and FIG. 5. Examples of the one or more sensors may include, but not limited to, an accelerometer sensor, a magnetometer sensor, and a gyroscope sensor. The one or more sensors may capture relevant information associated with position and orientation of a user, along with information associated about surroundings of the user, such as environmental conditions. The voice-based navigation module 140 is further configured to determine one or more optimal points of interest (PoIs) with respect to the determined current FoV of the user, as described in conjunction with FIG. 6 to FIG. 14B. The PoIs are selected based on their relevance and proximity to the current FoV of the user, which may represent locations, landmarks, or objects that are potentially important for the user's navigation purposes. The voice-based navigation module 140 is further configured to generate a response for the voice-based navigation based on at least one of the one or more optimal PoIs and the determined current FoV of the user, as described in conjunction with FIG. 15 to FIG. 19. The response may include spoken directions, instructions, or guidance to assist the user in navigating to a desired destination or interacting with the one or more determined PoIs.

In an exemplary scenario, a user may be walking in a city using the electronic device 100 with voice-based navigation capabilities. The one or more sensors may detect the user's surroundings, including buildings, streets, and landmarks. Based on the current FOV of the user, the electronic device 100 may determine the one or more optimal PoIs within the current FoV of the user, such as nearby restaurants, tourist attractions, or transportation hubs. The electronic device 100 may then generate voice instructions, providing the user with real-time guidance and relevant information about the PoIs. For instance, the electronic device 100 may generate voice instruction comprising, “turn left at the next intersection to reach the famous landmark on your right.” By utilizing the current FoV of the user and selecting relevant PoIs, the voice-based navigation system enhances the user's navigation experience and provides tailored guidance based on their immediate surroundings.

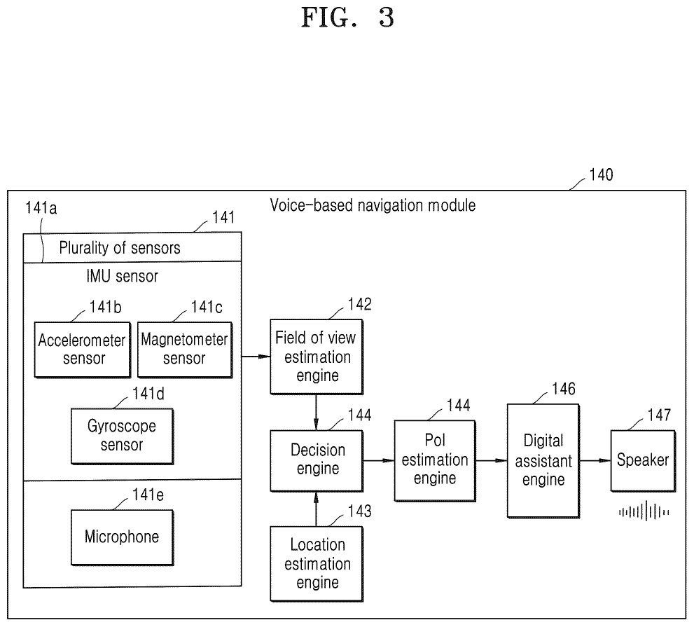

In one or more embodiments, the voice-based navigation module 140 includes one or more sub-modules which may be configured to generate the response for the voice-based navigation, as described in conjunction with FIG. 3.

A function associated with the various components of the electronic device 100 may be performed through the non-volatile memory, the volatile memory, and the processor 120. One or a plurality of processors 120 controls the processing of the input data in accordance with a predefined operating rule or AI model stored in the non-volatile memory and the volatile memory. The predefined operating rule or AI model is provided through training or learning. Here, being provided through learning means that, by applying a learning techniques to learning data, a predefined operating rule or AI model of the desired characteristic may be prepared. The learning may be performed in a device itself in which AI according to an embodiment is performed, and/or may be implemented through a separate server/system. The learning techniques is a method for training a predetermined target device (for example, a robot) using a plurality of learning data to cause, allow, or control the target device to decide or predict. Examples of learning techniques include, but are not limited to, supervised learning, unsupervised learning, semi-supervised learning, or reinforcement learning.

The AI model may consist of a plurality of neural network layers. Each layer has a plurality of weight values and performs a layer operation through a calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

Although FIG. 2 shows various hardware components of the electronic device 100, but it is to be understood that other embodiments are not limited thereon. In other embodiments, the electronic device 100 may include less or more number of components. Further, the labels or names of the components are used only for illustrative purposes and do not limit the scope of the invention. One or more components can be combined to perform the same or substantially similar functions for the voice-based navigation.

FIG. 3 illustrates a block diagram of the voice-based navigation module 140 associated with the electronic device 100 for the voice-based navigation, according to an embodiment of the disclosure.

In one or more embodiments, the voice-based navigation module 140 may include a plurality of sensors 141, a field of view estimation engine 142, a location estimation engine 143, a decision engine 144, a PoI estimation engine 145, a digital assistant engine 146, and a speaker 147.

The plurality of sensors 141 may include an IMU sensor 141a (e.g., an accelerometer sensor 141b, a magnetometer sensor 141c, and a gyroscope sensor 141d), and a microphone 141e. The IMU sensor 141a is configured to determine at least one of a roll angle (e.g., −10 degrees), a pitch angle (e.g., 20 degrees), and a yaw angle (e.g., 45 degrees) associated with a head orientation of the user, as described in conjunction with FIG. 4A and FIG. 4B.

The field of view estimation engine 142 is configured to determine a vertical FoV (e.g., 114 degrees) and a horizontal FoV (e.g., 94 degrees) of the user, based on the at least one of the roll angle, the pitch angle, and the yaw angle. The field of view estimation engine 142 is further configured to determine the current FoV of the user based on the determined vertical FoV and the determined horizontal FoV, as described in conjunction with FIG. 5.

The location estimation engine 143 is configured to determine a current location of the user, as described in conjunction with FIG. 6. The current location of the user may include latitude information (e.g., 37.7749° N), longitude information (e.g., 122.4194° W), and altitude information (e.g., 50 meters).

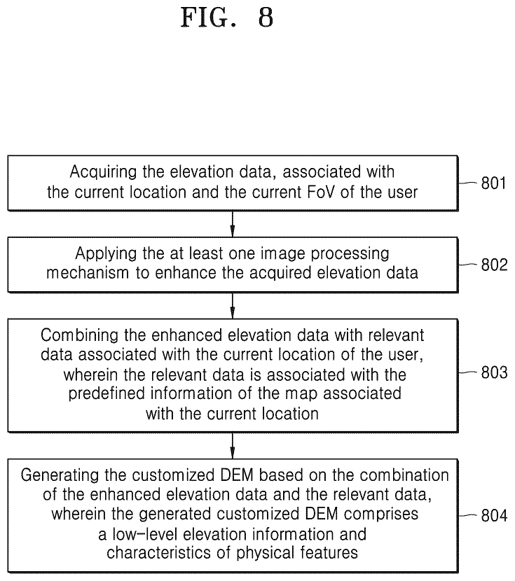

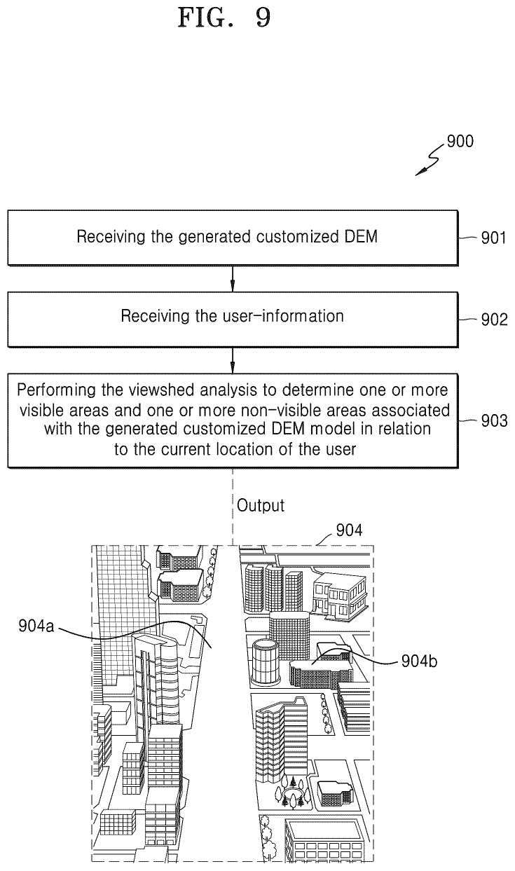

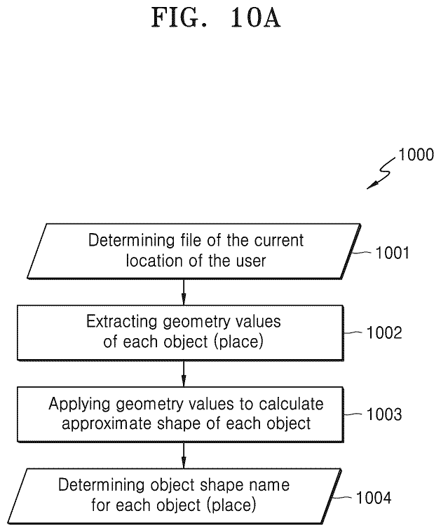

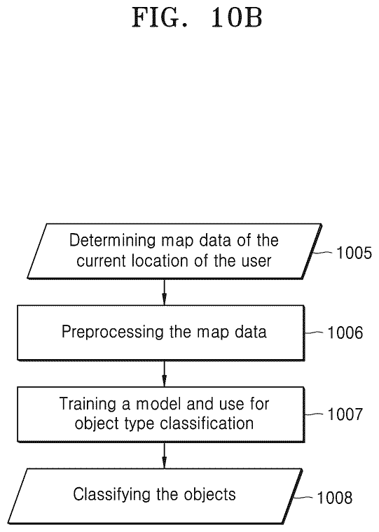

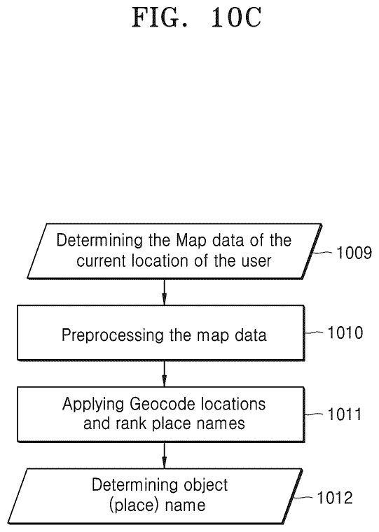

The decision engine 144 is configured to generate a customized digital elevation model (DEM) of the current location of the user, as described in conjunction with FIG. 8. The decision engine 144 is further configured to determine one or more visible areas and one or more non-visible areas associated with the generated customized DEM in relation to the current location of the user, as described in conjunction with FIG. 9. The decision engine 144 is further configured to determine the list of candidate PoIs and the information associated with each candidate PoI based on at least one of the generated customized DEM, the determined one or more visible areas, the determined one or more non-visible areas, and one or more object recognition mechanisms, as described in conjunction with FIG. 10A to 10C.

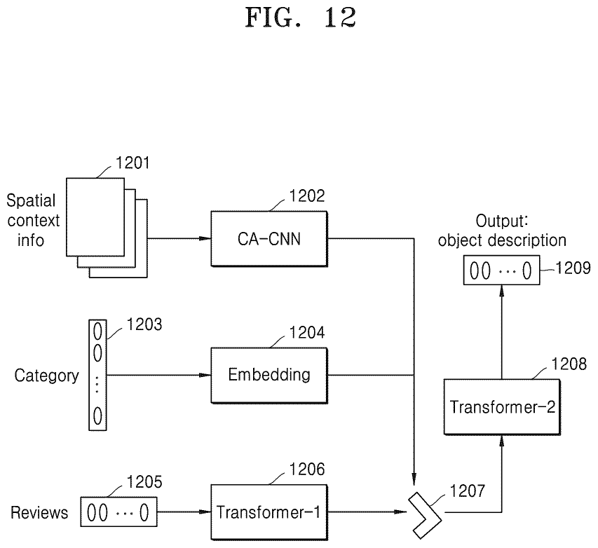

The PoI estimation engine 145 is configured to determine a list of candidate PoIs and information associated with each candidate PoI, based on the current FoV of the user and the current location of the user. The information associated with each candidate PoI comprises at least one of a candidate object identity (e.g., object-1, object-2, etc.), a candidate object shape (e.g., circle, square, etc.), a candidate object type (e.g., tree, small building, etc.), a candidate object name (e.g., star shop), a visible area information, a distance information, an angle information, and a location information. The PoI estimation engine 145 is further configured to determine a description of each candidate PoI from the list of candidate PoIs, as described in conjunction with FIG. 12, based on at least one of a spatial context information associated with each candidate PoI, category information associated with each candidate PoI, and review information associated with each candidate PoI.

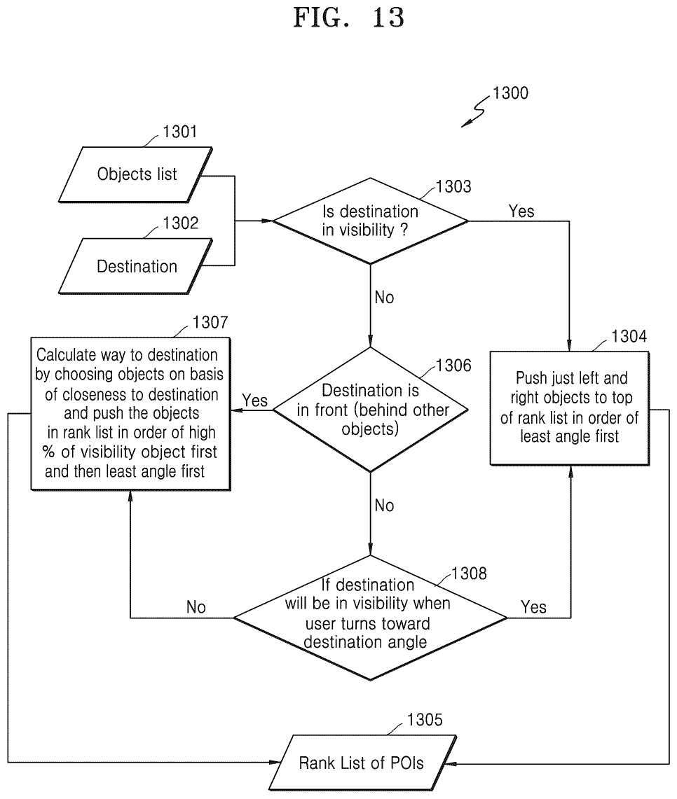

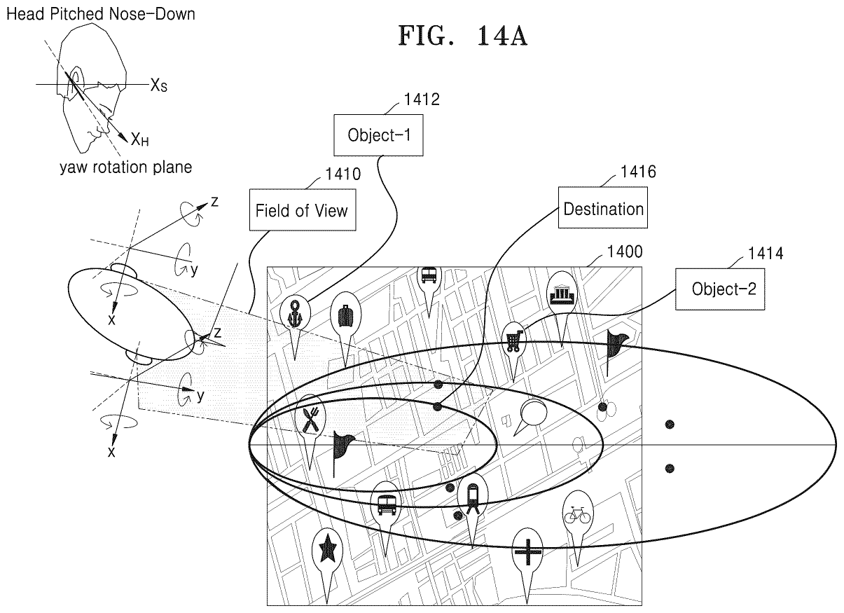

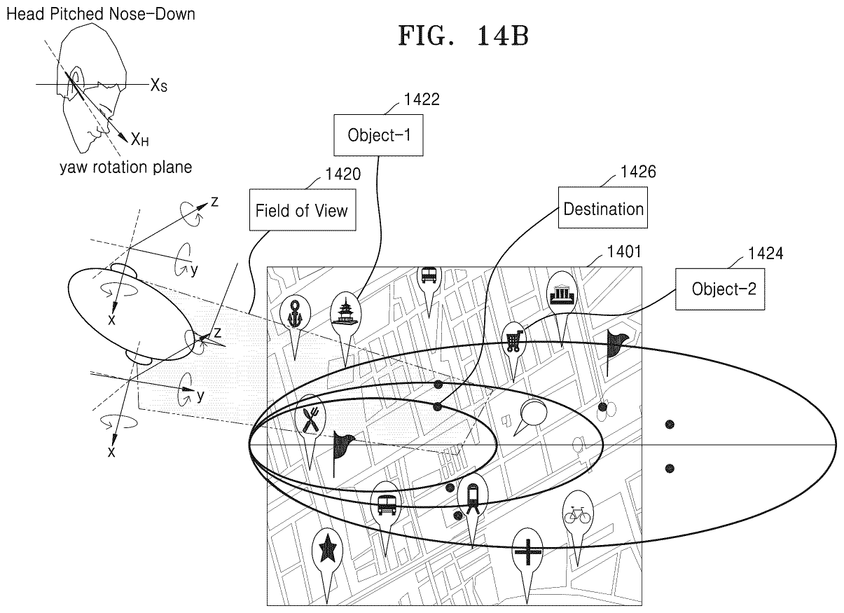

The PoI estimation engine 145 is further configured to determine a priority of each candidate PoI from the list of candidate PoIs based on the determined description and one or more ranking parameters. The PoI estimation engine 145 is further configured to determine the one or more optimal PoIs based on the determined priority as described in conjunction with FIGS. 13, 14A, and 14B.

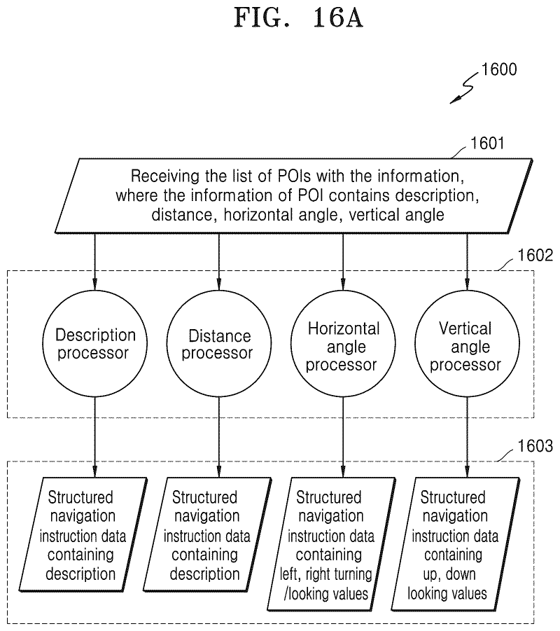

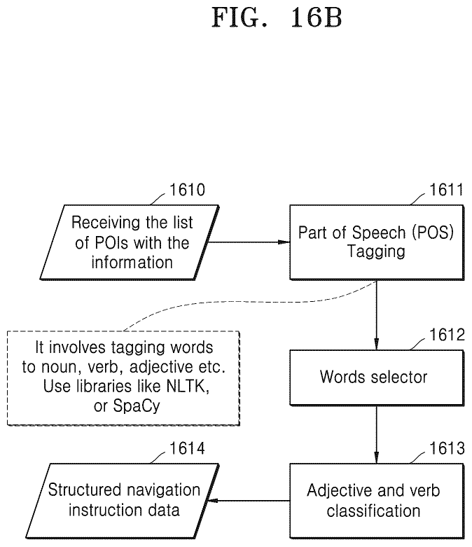

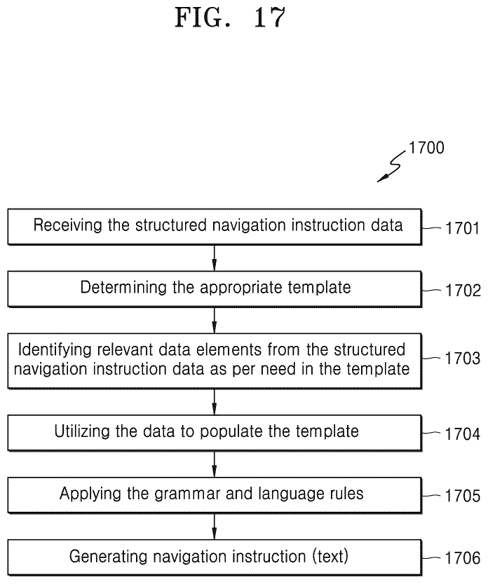

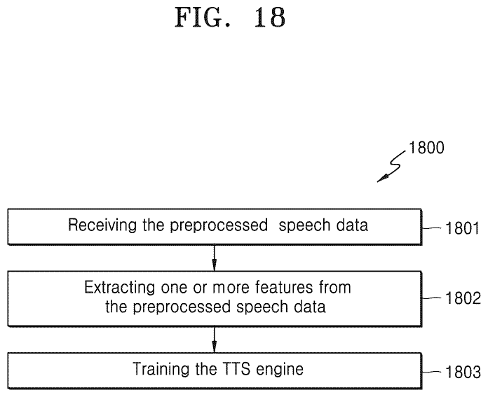

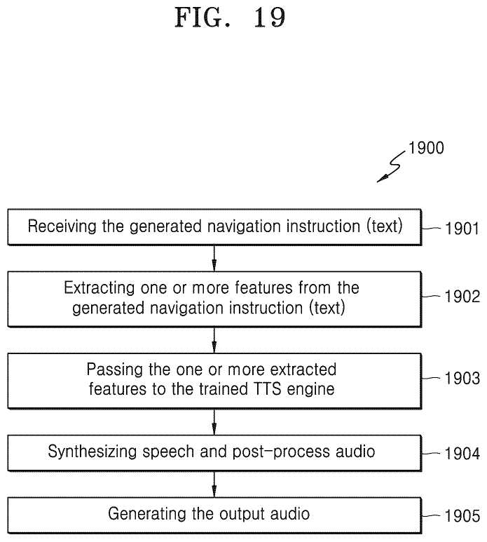

The digital assistant engine 146 is configured to generate one or more structured navigation instruction data for information associated with each candidate PoI, as described in conjunction with FIGS. 16A and 16B. The digital assistant engine 146 is further configured to generate one or more navigation instruction texts from the one or more generated structured navigation instructions, as described in conjunction with FIG. 17. The digital assistant engine 146 is further configured to convert the generated one or more navigation instruction texts into navigation instruction audio to generate the response for the voice-based navigation by utilizing the speaker 147, as described in conjunction with FIG. 18 and FIG. 19.

FIGS. 4A and 4B illustrate exemplary scenarios to determine the roll angle, the pitch angle, and the yaw angle associated with the head orientation of the user, according to the related art.

In FIG. 4A, the IMU sensor 141a is a traditional sensor. The IMU sensor 141a may determine a change in the FoV of the user by tracking Euler angles (e.g., the roll angle (φ), the pitch angle (θ), and the yaw angle (ψ)) produced by the head orientation of the user.

The roll angle (φ) is determined using the accelerometer sensor 141b. The roll angle (φ) represents a rotation around the z-axis, indicating the side-to-side tilt of the user's head. A roll angle (φ) of zero degrees suggests that the user's head is not tilted to either side. Similarly, the pitch angle (θ) is determined using the magnetometer sensor 141c. The pitch angle (θ) represents a rotation around the x-axis, indicating the up and down tilt of the user's head. A pitch angle (θ) of zero degrees indicates that the user's head is neither tilted nor inclined. Furthermore, the yaw angle (ψ) is determined using the gyroscope sensor 141d. The yaw angle (ψ) represents a rotation around the y-axis, describing the left and right rotation of the user's head. A yaw angle (ψ) of zero degrees signifies that the user's head is facing exactly north.

The accelerometer sensor 141b, the magnetometer sensor 141c, and the gyroscope sensor 141d are utilized to determine the roll angle (φ), the pitch angle (θ), and the yaw angle (ψ), which provide information about the tilt, inclination, and orientation of the user's head. The angles may be understood through example scenarios. In an exemplary scenario where the user is wearing a virtual reality (VR) headset for gaming, the roll angle (φ) determined by the accelerometer sensor 141b indicates the side-to-side tilt of the user's head. When the user tilts his or her head to the right, the roll angle (φ) may be positive, indicating the rightward tilt. Similarly, if the user tilts his or her head to the left, the roll angle (φ) may be negative, indicating the leftward tilt. Now, in an exemplary scenario where the user is using a head-mounted display for augmented reality (AR) applications, the pitch angle (θ) determined by the magnetometer sensor 141c may reflect the up and down tilt of the user's head. If the user tilts his or her head upwards, the pitch angle (θ) may be positive, indicating the upward tilt. Conversely, if the user tilts his or her head downwards, the pitch angle (θ) may be a negative value, indicating the downward tilt. Lastly, in an exemplary scenario where the user is engaged in a virtual tour using a head-mounted display. The yaw angle (ψ) (determined by the gyroscope sensor 141d) represents the left and right rotation of the user's head. If the user rotates his or her head to the right, the yaw angle (ψ) may be positive, which indicates the rightward rotation. Similarly, if the user rotates his or her head to the left, the yaw angle (ψ) may be negative, which indicates the leftward rotation.

FIG. 4B illustrates a conventional method 400 for determining the Euler angles (e.g., the roll angle (φ), the pitch angle (θ), and the yaw angle (ψ)). In operation 401 of the conventional method 400, the pitch angle (θ) and the roll angle (φ) are determined using accelerometer readings associated with the accelerometer sensor 141b. The step-by-step procedure for performing this determination is described below.
a. The conventional method 400 includes determining the accelerometer readings, denoted as a=[aₓ, a_{y}, a_{z}], where aₓ, a_{y}, and a_{z} are measured accelerations along the x, y, and z axes respectively.
b. The conventional method 400 includes determining magnitude of the “a” by using the equation-1.

$$\vert a \vert = \sqrt{{ax}^{2} + {ay}^{2} + {az}^{2}} \qquad ( 1 )$$

c. The conventional method 400 includes normalizing the magnitude of the “a” by using the equation-2.

$$a\_norm = a / \vert a \vert \qquad ( 2 )$$

d. The conventional method 400 includes determining the pitch angle (θ) by using the equation-3. It is important to note that a negative sign is utilized as a positive pitch angle (θ) indicates a downward tilt of the user's head, which is opposite to the direction of gravity.

$$a\_pitch = asin ( - a\_norm . x ) \qquad ( 3 )$$

e. The conventional method 400 includes determining the roll angle (φ) by using the equation-4.

$$a\_roll = atan 2 ( a\_norm . y , a\_norm . z ) \qquad ( 4 )$$

In operation 402 of the conventional method 400, the yaw angle (ψ) is determined using magnetometer readings associated with the magnetometer sensor 141c. The step-by-step procedure for performing this determination is described below.
a. The conventional method 400 includes determining the magnetometer readings, denoted as M=[Mₓ, M_{y}, M_{z}], where Mₓ, M_{y}, and M_{z} are measured magnetic field strength along the x, y, and z axes respectively.
b. The conventional method 400 includes determining values associated with the a_roll and the a_pitch.
c. The conventional method 400 includes determining the yaw angle (ψ) by using the equation-5.

$$m\_yaw = atan 2 ( My * cos ( a\_roll ) + Mz * sin ( a\_roll ) , Mx * cos ( a\_pitch ) + My * sin ( a\_pitch ) * sin ( a\_roll ) + Mz * sin ( a\_pitch ) * cos ( a\_roll ) ) \qquad ( 5 )$$

In operation 403 of the conventional method 400, the roll angle (φ), the pitch angle (θ), and the yaw angle (ψ) are determined using gyroscope readings associated with the gyroscope sensor 141d. The step-by-step procedure for performing this determination is described below.
a. The conventional method 400 includes determining an orientation given by the accelerometer sensor 141b (e.g., the output of the operation 401) and the magnetometer sensor 141c (e.g., the output of the operation 402) are roll₀, yaw₀, and pitch₀.
b. The conventional method 400 includes determining the gyroscope readings w (t)=[wₓ(t), w_{y}(t), w_{z}(t)], wherein the readings are sampled at a fixed time interval delta_t.
c. The conventional method 400 includes determining the angles (φ, θ, and ψ) based on the fixed time interval delta_t by using the equations 6, 7, and 8.

$$\begin{matrix}delta\_roll = wx ( t ) * delta\_t & ( 6 ) \\ delta\_pitch = wy ( t ) * delta\_t & ( 7 ) \\ delta\_yaw = wz ( t ) * delta\_t & ( 8 )\end{matrix}$$

d. The conventional method 400 includes determining updated angles (φ, θ, and ψ) by using the equations 9, 10, and 11.

$$\begin{matrix}roll 1 = roll 0 + delta\_roll & ( 9 ) \\ pitch 1 = pitch 0 + delta\_pitch & ( 10 ) \\ yaw 1 = yaw 0 + delta\_yaw & ( 11 )\end{matrix}$$

In operations 404 and 405 of the conventional method 400, accurate values of the Euler angles are estimated by fusing data from multiple sensors (e.g., the accelerometer sensor 141b, the magnetometer sensor 141c, and the gyroscope sensor 141d). This fusion process involves the utilization of one or more methodologies such as a complementary filter and a Kalman filter.

The complementary filter is configured to employ a weighted average approach to combine data from the multiple sensors. Additionally, the complementary filter effectively is configured to combine the strengths of each sensor by assigning appropriate weights to each sensor's data and producing a more accurate estimation of the Euler angles. The Kalman filter is configured to utilize a series of measurements taken over time to estimate the Euler angles. Additionally, the Kalman filter is configured to predict and update the values of the Euler angles by considering the previous measurements and uncertainties of the previous measurements, resulting in a refined and precise estimation. Additionally, the IMU sensor 141a is configured to send the accurate values of the Euler angles to the field of view estimation engine 142 for further processing, as described in FIG. 5.

FIG. 5 illustrates an exemplary scenario to determine the current FoV of the user, according to an embodiment of the disclosure.

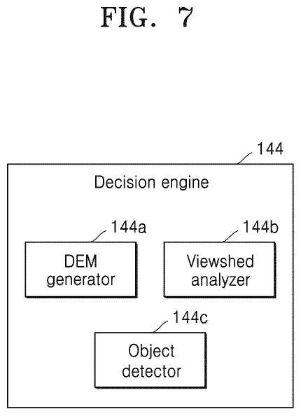

The field of view estimation engine 142 may determine the vertical FoV and the horizontal FoV of the user based on the Euler angles (e.g., the roll angle (φ), the pitch angle (θ), and the yaw angle (ψ)). In an embodiment, the field of view estimation engine 142 is configured to send information associated with the vertical FoV and the horizontal FoV to the decision engine 144 for further processing, as described in FIG. 7.

In operation 501, the vertical FoV is a vertical range that the user may see without moving the head or eyes. The vertical FoV is influenced by factors such as a height of the user, a central line of sight of the user, and a pitch angle of the user. The height of the user is a significant factor in establishing the vertical FoV. For example, a relatively taller user naturally has a higher vantage point, allowing him or her to observe a bigger vertical area than a shorter user. The central line of sight refers to an imaginary line that runs straight ahead from the user's eyes, which serves as a reference for determining the vertical boundaries. The pitch angle, which represents the up or down tilt of the user's head, also affects the vertical FoV. Tilting the head upward or downward changes the range of the vertical FOV accordingly.

In operation 502, the horizontal FoV is a range of the surrounding environment that the user may visually capture without moving the head or eyes horizontally, which indicates how much of the left and right side of the visual field is covered. The horizontal FoV is influenced by factors such as the central line of sight of the user and the yaw angle. The central line of sight is an imaginary line that runs straight ahead from the user's eyes, which serves as a reference for determining the horizontal boundaries. The yaw angle represents the rotation or turning of the user's head from side to side. By changing the yaw angle, the user may adjust the horizontal FoV, expanding or narrowing a range of a visual perception in the left and right directions.

In one or more embodiments, the direction of the center line of sight is relative to the horizontal and vertical planes, which may be determined as follows.
a. Combined rotation matrix given as:

$${R}_{combines} = [ \begin{matrix}cos {yaw}_{red} . cos {pitch}_{red} & cos {yaw}_{red} . sin {pitch}_{red} . sin {roll}_{red} - sin {yaw}_{reed} . cos {roll}_{red} & cos {yaw}_{red} . sin {pitch}_{red} . cos {roll}_{red} + sin {yaw}_{red} . sin {roll}_{red} \\ sin {yaw}_{red} . cos {pitch}_{red} & sin {yaw}_{red} . sin {pitch}_{red} . sin {roll}_{red} + cos {yaw}_{reed} . cos {roll}_{red} & sin {yaw}_{red} . sin {pitch}_{red} . cos {roll}_{red} - cos {yaw}_{red} . sin {roll}_{red} \\ - sin pitch\_rad & cos {pitch}_{red} . sin {roll}_{red} & cos {pitch}_{red} . cos {roll}_{red}\end{matrix} ]$$

where yaw_{rad}, pitch_{rad}, and roll_{rad} are yaw, pitch, and roll angles in radian.
b. Determine direction vector d which represents the direction of the center line of sight relative to horizontal and vertical planes d=R_{combined}*[0 0 1] where the matrix [0 0 1] is representing starting direction of center line of sight.
c. Suppose direction vector d is represented as (dₓ, d_{y}, d_{z}).
d. Determine an angle between center line of sight and horizontal plane, azimuth angle=arctan 2 (d_{y}, dₓ).
e. Determine an angle between center line of sight and vertical plane, elevation angle=arcsin (d_{z}).

FIG. 6 illustrates an exemplary scenario 600 to determine the current location of the user, according to the related art. The location estimation engine 143 determines the current location of the user by using, for example, a global navigation satellite system (GNSS).

The location estimation engine 143 in the disclosed method is configured to determine the current location of the user using a combination of GPS satellites 601, ground control stations 602, and GPS receivers 603. The disclosed method may rely on a global navigation satellite system (GNSS) for determining the current location of the user. For example, the GPS satellites 601 are positioned in various orbits around the Earth, approximately 20,000 km above the surface. Each orbit consists of four GPS satellites 601, which move in a 12-hour interval. The ground control stations 602 are configured to monitor, control, and maintain orbit to make sure that the deviation of the one or more GPS satellites 601 from the orbit as well as GPS timing are within a tolerance level. The GPS receivers 603, such as smartphones or earbuds, may establish communication with the GPS satellites 601 and collect the necessary data to generate national marine electronics association (NMEA) data 604, which contains information about the current location of the user 605. In an embodiment, the location estimation engine 143 is configured to send information associated with the current location of the user to the decision engine 144 for further processing, as described in FIG. 7.

FIG. 7 illustrates a block diagram of the decision engine 144 associated with the voice-based navigation module 140, according to an embodiment of the disclosure. The decision engine 144 may include, for example, a plurality of modules, wherein the plurality of modules includes a DEM generator 144a, a viewshed analyzer 144b, and an object detector 144c.

In one or more embodiments, the DEM generator 144a is configured to generate a customized digital elevation model (DEM) of the current location of the user. The customized DEM represents a topography and elevation of an area in a digital format. To generate the customized DEM, the DEM generator 144a may follow several operations, as illustrated in FIG. 8. Firstly, the DEM generator 144a is configured to acquire elevation data from different sources such as light detection and ranging (LiDAR) mechanism, satellite imagery, or contour maps. These different sources may provide information about elevation data at various points across the current location of the user. Next, the DEM generator 144a is configured to perform various image processing mechanisms on the elevation data, such as filtering, smoothing, and interpolation processes, which helps to eliminate noise or irregularities in the data and ensures a more accurate representation of the terrain.

In addition to the elevation data, the DEM generator 144a is configured to integrate other relevant information such as water bodies and infrastructure into the generated customized DEM, which enhances completeness and contextual accuracy of the generated customized DEM. Finally, the DEM generator 144a is configured to create a 3D representation of the current location of the user, where each pixel corresponds to a specific elevation value. As a result, the DEM generator 144a generates a comprehensive and precise DEM associated with the current location of the user.

In one or more embodiments, the viewshed analyzer 144b is configured to analyze the visibility of areas based on the customized DEM, as described in conjunction with FIG. 9. The viewshed analyzer 144b is configured to determine which areas are visible and which areas are non-visible from the current location of the user by utilizing the generated customized DEM and the user-information. The user-information includes various parameters such as the current location of the user, the height of the user, the roll angle (φ), the pitch angle (θ), the yaw angle (ψ), the vertical FoV, and the horizontal FoV. For example, a scenario where the user is standing on a hill and wants to know which areas are visible from the current location. The viewshed analyzer 144b then may take into account the generated customized DEM, which represents the terrain, and the user-information, including the current location, the height of the user, and viewing angles (e.g., vertical FoV and the horizontal FoV). Using this information, the viewshed analyzer 144b may then determine the visible areas, which are those that are within the FoV of the user and not obstructed by any objects or terrain. The viewshed analyzer 144b may also determine the non-visible areas, which are either outside the FoV of the user or blocked from view due to obstacles.

In one or more embodiments, the object detector 144c is configured to determine one or more object parameters associated with the current FoV of the user and the current location of the user, as described in conjunction with FIG. 10. The one or more object parameters include the object identity, the object shape, the object type, and the object name. The object identity is a unique numerical identifier assigned to each identifiable object in the vicinity of the current location of the user. For example, if the user is in a park, trees may be assigned ID numbers such as “1”, “2”, and so on. The object shape represents the approximate shape of the identified object, such as a circle, square, triangle, rectangle, or polygon. This shape recognition is performed using an object shape recognition application programming interface (API). The object type refers to a category or classification of the object, which may be derived from location type information if available. If the location type information is not available, the object recognition API is utilized to determine the object type. In an embodiment, the object name, if available, corresponds to a specific name associated with the object, similar to a location name.

In one or more embodiments, the decision engine 144 is configured to determine the list of candidate PoIs and information associated with each candidate PoI. The information associated with each candidate PoI comprises the at least one of the candidate object identity, the candidate object shape, the candidate object type, the candidate object name, the visible area information, the distance information, the angle information, and the location information, for example, as described in Table-1 below.

TABLE 1

| | | | | | | Angle | |
|---|---|---|---|---|---|---|---|
| Object | Object | Object | Object | Visible | Distance | (horizontal, | Latitude, |
| identity | shape | type | name | area % | (in meters) | vertical) | longitude |
| 1 | Square | Pond | Null | 40% | 20 | 58°, 30° | 40.7128, |
| | | | | | | | −74.0060 |
| 2 | Polygon | Small | Delhi | 19% | 18 | 178°, −20° | 40.7152, |
| | | building | Emporium | | | | −74.0113 |
| 3 | Circle | Tree | Null | 78% | 29 | −30°, 10° | 40.7140, |
| | | | | | | | −74.0134 |

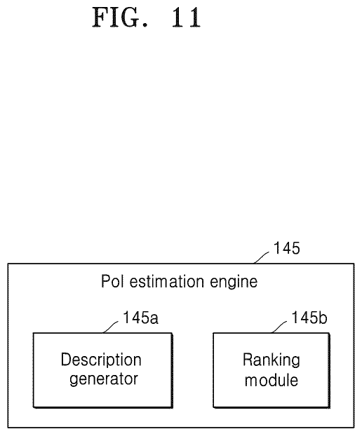

In an embodiment, the decision engine 144 is configured to send information associated with each candidate PoI to the PoI estimation engine 145 for further processing, as described in FIG. 11.

FIG. 8 is a flow diagram illustrating a method 800 for generating the customized DEM of the current location of the user, according to an embodiment of the disclosure. To generate the customized DEM, the DEM generator 144a may follow several operations, which are described below.

At operation 801, the method 800 includes acquiring the elevation data, associated with the current location and the current FoV of the user.

At operation 802, the method 800 includes applying at least one image processing mechanism to enhance the acquired elevation data.

At operation 803, the method 800 includes combining the enhanced elevation data with relevant data associated with the current location of the user, wherein the relevant data is associated with the predefined information of the map associated with the current location.

At operation 804, the method 800 includes generating the customized DEM based on the combination of the enhanced elevation data and the relevant data. In an embodiment, the generated customized DEM may include a low-level elevation information and characteristics of physical features (e.g., building, road, etc.).

FIG. 9 is a flow diagram illustrating a method 900 for determining one or more visible areas and one or more non-visible areas associated with the generated customized DEM in relation to the current location of the user, according to an embodiment of the disclosure. To determine the one or more visible areas and one or more non-visible areas, the viewshed analyzer 144b may follow several operations, which are described below.

At operation 901, the method 900 includes receiving the generated customized DEM from the DEM generator 144a.

At operation 902, the method 900 includes receiving the user-information. The user-information includes various parameters, such as at least one of the current location of the user, the height of the user, the roll angle (φ), the pitch angle (θ), the yaw angle (ψ), the vertical FoV, and the horizontal FoV.

At operations 903, the method 900 includes performing the viewshed analysis to determine one or more visible areas 904a and one or more non-visible areas 904b associated with the generated customized DEM model in relation to the current location of the user.

FIGS. 10A, 10B, and 10C are flow diagrams illustrating a method 1000 for determining object information, according to an embodiment of the disclosure. In some embodiments, all operations associated with the flow diagrams may be performed by the object detector 144c.

In FIG. 10A, at operation 1001, the method 1000 includes obtaining a file from an online database, which corresponds to the current location of the user. The file may be in various formats such as a shape file or a GeoJSON file. The shape file is a geospatial vector data format specifically designed for storing information about geographic features, including points, lines, and polygons. The GeoJSON file is a newer geospatial data format that is based on the widely used JavaScript object notation (JSON) format. Like shape files, GeoJSON files are also used to store information about geographic features such as points, lines, and polygons.

At operation 1002, the method 1000 includes extracting the geometry values of each object associated with the current location of the user, utilizing the file obtained in operation 1001.

At operation 1003, the method 1000 includes applying the extracted geometry values to calculate the approximate shape of each object. This operation helps in determining the general shape of the objects, which could be circular, square, rectangular, polygonal, and so on.

At operation 1004, the method 1000 includes determining the object shape name for each object. This means assigning a specific shape label to each object based on the calculated approximate shape, such as circle, square, rectangle, polygon, and other possible shape names. By following the method 1000, the electronic device 100 can effectively process the data associated with the current location of the user, extract geometry values, calculate approximate shapes, and assign shape names to each object, and enabling further analysis.

In FIG. 10B, at operation 1005, the method 1000 includes determining map data of the current location of the user. The map data comprises various information such as at least one of satellite imagery and street maps. Several application programming interfaces (APIs), such as Google Maps, OpenStreetMap, or Mapbox, may be utilized to obtain the map data.

At operation 1006, the method 1000 includes pre-processing the determined map data. During the pre-processing, relevant features that are crucial for object type classification are extracted. These features may include the object's name (if available), color, texture, shape, size, and other characteristic attributes.

At operation 1007, the method 1000 includes training to a model using the pre-processed map data. The model is specifically trained for object type classification, and it learns patterns and relationships between the extracted features and different object types.

At operation 1008, the method 1000 includes classifying each object based on the trained model. For instance, objects can be classified into categories such as ponds, small buildings, trees, big buildings, restaurants, hostels, shops, and so on. This classification process allows for efficient labeling and organization of each object present in the map data.

In FIG. 10C, at operation 1009, the method 1000 includes determining the map data corresponding to the current location of the user. The map data may provide information about the surrounding area, including landmarks, buildings, parks, and other points of interest.

At operation 1010 the method 1000 includes preprocessing the determined map data to extract features that are relevant for identifying place names. For example, various characteristics, such as location coordinates, size, shape, and other relevant attributes, are extracted from the map data.

At operation 1011, the method 1000 includes applying geocode locations to the extracted features, and a geocoding API is utilized to match the locations of objects on the map with known place names. The geocoding API helps in associating the identified objects with their corresponding place names. The place names returned by the geocoding API are ranked based on their relevance to the object on the map, ensuring accurate identification and labeling of the places.

At operation 1012, the method 1000 includes determining the object name based on the ranked place names. For example, if the object on the map corresponds to the coordinates of ‘Salesforce Tower,’ ‘Golden Gate Bridge,’ or ‘Central Park,’ the method 1000 may assign the respective object name to it, which enables the user to easily identify and reference specific landmarks and locations on the map.

FIG. 11 illustrates a block diagram of the PoI estimation engine 145 associated with the voice-based navigation module 140, according to an embodiment of the disclosure.

The PoI estimation engine 145 includes a description generator 145a and a ranking module 145b. Upon receiving the list of candidate PoIs and information associated with each candidate PoI from the decision engine 144, the description generator 145a is configured to generate the description of each candidate PoI from the list of candidate PoIs based on the spatial context information associated with each candidate PoI, the category information associated with each candidate PoI, and the review information associated with each candidate PoI, as described in conjunction with FIG. 12. The ranking module 145b is configured to determine the priority of each candidate PoI from the list of candidate PoIs based on the generated description and one or more ranking parameters (e.g., proximity to the user's location, relevance to the user, popularity, etc.). The ranking module 145b is further configured to determine the one or more optimal PoIs based on the determined priority, as described in conjunction with FIGS. 13 to 14B.

In an embodiment, the PoI estimation engine 145 is configured to send the determined priority to the digital assistant engine 146 for further processing, as described in FIG. 15.

FIG. 12 illustrates various operations of the description generator 145a associated with the PoI estimation engine 145, according to an embodiment of the disclosure.

The description generator 145a includes several modules designed to generate descriptions for each candidate's Point of Interest (PoI) from a list of candidates. These modules include a Context Aware Convolutional Neural Network (CA-CNN) module 1202, an embedding module 1204, a transformer-1 module 1206, a fusion module 1207, and a transformer-2 module 1208.

The CA-CNN module 1202 is configured to receive and process on a context tensor created using spatial context information 1201 associated with each candidate PoI. The spatial context information 1201 includes physical features such as shape, type, name, latitude, and longitude.

The embedding module 1204 is configured to receive and process on various categories of each candidate PoI, such as shop, building, park, monument, fountain, streetlight, street, and more. Each category is represented by a one-hot category vector, which is embedded using a linear function, as shown below as Equation 12.

$${t}_{emb} = {W}_{t} t + {b}_{t} \qquad ( 12 )$$

Where Wₜ is a weight matrix and the bₜ is a bias vector.

The transformer-1 module 1206 is configured to extract key information from a large volume of reviews collected from multiple sources, including online review platforms, social media, local or regional publications, and guides about the place. The transformer-1 module 1206 is configured to utilize stacking one embedding layer and six self-attention layers to process the reviews (e.g., x={x₁, x₂, . . . , xₙ}) of each candidate PoI and calculate a latent encoded representation.

The fusion module 1207 is configured to receive information from the CA-CNN module 1202, the embedding module 1204, and the transformer-1 module 1206 for further processing. The fusion module 1207 is configured to combine the information by applying a linear function over the concatenation [eᵣₑᵥ; t_{emb}; Cₛₚₐ] of the context tensor, the embedded category vector, and the spatial context information, as shown below equation 13.

$${e}_{fused} = {W}_{f} [ {e}_{rev} ; {t}_{emb} ; {c}_{spa} ] + {b}_{f} \qquad ( 13 )$$

Here, the parameter W_{f} is a matrix, and the parameter b_{f} is a vector.

The transformer-2 module 1208 is configured to receive the fused information from the fusion module 1207 for further processing. It consists of two self-attention layers and a SoftMax layer, serving as a decoder to generate the final output 1209, which is the description of the candidate PoI.

By employing these modules (e.g., the CA-CNN module 1202, the embedding module 1204, the transformer-1 module 1206, the fusion module 1207, and the transformer-2 module 1208) in the description generator 145a, the disclosed method may comprise generating informative and contextually relevant descriptions (the final output 1209) for each candidate PoI, which may enhance the user's understanding of the PoIs and improves the overall experience while exploring different locations.

FIG. 13 is a flow diagram illustrating a method 1300 for determining the priority of each candidate PoI from the list of candidate PoIs, according to an embodiment of the disclosure. Operations 1301 to 1308 may be performed by the ranking module 145b.

At operations 1301 and 1302, the method 1300 includes receiving the list of candidate PoIs and the destination point is associated with at least one candidate PoI from the list of candidate PoIs.

At operations 1303 and 1304, the method 1300 includes ranking the list of candidate PoIs based on the angle information when the destination point belongs to the one or more visible areas. In other words, for the angle information, the least angle is given a high priority. This approach may ensure that the objects positioned to a left object and a right object, with reference to the user's center line of sight, are given due importance and are visible to users at first glance. By pushing these objects to the top of the list, enhance the user experience and make it easier for them to navigate through the PoIs.

At operations 1303, 1304, 1306, and 1308, the method 1300 includes ranking the list of candidate PoIs based on the angle information when the destination point does not belong to the one or more visible areas. The destination point does not belong to a front side of the user. The destination point belongs to the one or more visible areas when the user turns towards a destination angle.

At operations 1303, 1306, and 1307, the method 1300 includes ranking the list of candidate PoIs based on the distance information, the visible area information, and the angle information when the destination point does not belong to the one or more visible areas and the destination point belongs to the front side of the user. In other words, for the distance information, the object that is close to the destination point has the highest priority.

At operations 1303, 1306, and 1308, the method 1300 includes ranking the list of candidate PoIs based on the distance information, the visible area information, and the angle information when the destination point does not belong to the one or more visible areas, the destination point does not belong to the front side of the user, and the destination point does not belong to the one or more visible areas when the user turns towards the destination angle.

The ranking module 145b is configured to determine the priority of each candidate PoI from the list of candidate PoIs based on one or more logics. Here are the different scenarios and the corresponding logic used by the ranking module 145b:
a. If the destination point is within the one or more visible areas, the ranking module 145b is then configured to push a left object and a right object to the top of a rank list in order of angle changes. The left and right objects are considered in reference to the user's center line of sight. For example, if the user is looking at a point, there are a few objects on the left of that point, and a few are on the right of that point.
b. If the destination point is within the one or more non-visible areas but is located in front of the user and obstructed by other objects, the ranking module 145b is then configured to calculate a path to the destination point by selecting objects that are closest to the destination point. These objects are then pushed to the rank list based on their proximity to the destination point.
c. If the destination point will become visible to the user when they turn to a specific angle (e.g., destination angle), the ranking module 145b is then configured to prioritize objects on the left and right sides of the user's line of sight based on the angle changes. The list of candidate PoIs are sorted based on the angle information associated with each candidate PoI, giving higher priority to those with smaller angle changes.
d. If the destination point is not visible to the user when the user turns to the destination angle but is located at the destination angle behind other objects, the ranking module 145b is then configured to calculate a path to the destination point by selecting objects based on their closeness to the destination point. The objects that are closer to the destination point are given higher priority in the rank list.

By implementing these logic scenarios, the ranking module 145b ensures that the candidate PoIs are prioritized in a way that optimizes the user's experience and provides relevant information based on the current location and viewing direction. To illustrate the corresponding logic used by the ranking module 145b, in exemplary scenario presented in Table-2, where the details of one or more objects are provided in tabular format.

TABLE 2
Input

| object_{—} | | visible_{—} | | horizontal_{—} | vertical_{—} | | |
|---|---|---|---|---|---|---|---|
| id | description | area_% | distance | angle | angle | Latitude | longitude |
| #1 | {popularity: | 25 | 100 | 60 | 10 | 40.728 | −73.985 |
| | “4.3”, | | | | | | |
| | knowledge: | | | | | | |
| | “2.5”, | | | | | | |
| | detailed_{—} | | | | | | |
| | description: | | | | | | |
| | “ “, | | | | | | |
| | . . . } | | | | | | |
| #2 | {popularity: | 50 | 15 | −50 | 0 | 40.735 | −73.112 |
| | “0”, | | | | | | |
| | knowledge: | | | | | | |
| | “0”, | | | | | | |
| | detailed_{—} | | | | | | |
| | description: | | | | | | |
| | “ “, | | | | | | |
| | . . . } | | | | | | |
| #3 | {popularity: | 0 | 20 | 100 | −5 | 41.121 | −73.787 |
| | “2.2”, | | | | | | |
| | knowledge: | | | | | | |
| | “0”, | | | | | | |
| | detailed_{—} | | | | | | |
| | description: | | | | | | |
| | “ “, | | | | | | |
| | . . . } | | | | | | |
| #4 | {popularity: | 70 | 80 | 10 | −15 | 40.711 | −73.089 |
| | “0”, | | | | | | |
| | knowledge: | | | | | | |
| | “1.3”, | | | | | | |
| | detailed_{—} | | | | | | |
| | description: | | | | | | |
| | “ “, | | | | | | |
| | . . . } | | | | | | |
| #5 | {popularity: | 80 | 70 | 30 | −10 | 40.345 | −73.556 |
| | “5”, | | | | | | |
| | knowledge: | | | | | | |
| | “3”, | | | | | | |
| | detailed_{—} | | | | | | |
| | description: | | | | | | |
| | “ “, | | | | | | |
| | . . . } | | | | | | |
| #6 | {popularity: | 0 | 40 | −160 | 8 | 41.222 | −73.101 |
| | “4.2”, | | | | | | |
| | knowledge: | | | | | | |
| | “3”, | | | | | | |
| | detailed_{—} | | | | | | |
| | description: | | | | | | |
| | “ “, | | | | | | |
| | . . . } | | | | | | |

In this scenario, the destination object (e.g., destination point) is labeled as #3 and has the following characteristics: a horizontal angle of 100 degrees, a vertical angle of −5 degrees, and a visible area percentage of 0. These values indicate that if the user rotates horizontally by 100 degrees and vertically by −5 degrees, the destination object will be in that direction but not visible.

In the direction of the destination object, there are two nearby visible objects labeled as #1 and #5, positioned at horizontal angles of 60 and 30 degrees, respectively. Based on this information, the ranking module 145b is configured to apply the following logic:
e. Object #5, located at a horizontal angle of 30 degrees, is considered the most helpful object to the user in the current field of view. Therefore, it is pushed to rank 1.
f. Object #1, positioned at a horizontal angle of 60 degrees, is determined as the second most helpful object to the user. Consequently, it is pushed to rank 2.

By applying this logic, the ranking module 145b is configured to prioritize the objects in the rank list based on their relevance and assistance to the user's current direction and field of view. In this example, object #5 is considered the most useful object, followed by object #1, as they provide valuable information and guidance towards the destination object.

FIGS. 14A and 14B illustrate exemplary scenarios to determine the priority of each candidate PoI from the list of candidate PoIs, according to an embodiment of the disclosure.

In FIG. 14A, to further explain the determination of the priority of each candidate PoI from the list of candidate PoIs 1412, 1414, in an exemplary scenario depicted in Table-3 and visualized using Map 1400. Table-3 presents the details of various objects in a tabular format, providing information such as object ID and additional relevant attributes. In an embodiment, the map 1400 is utilized to visually represent the objects.

TABLE 3
Input

| object_{—} | | visible_{—} | | horizontal_{—} | vertical_{—} | | |
|---|---|---|---|---|---|---|---|
| id | description | area_% | distance | angle | angle | latitude | longitude |
| #1 | {popularity: | 50% | 60 | 50 | 10 | 41.121 | −73.112 |
| 1412 | “4.3”, | | | | | | |
| | knowledge: | | | | | | |
| | “2.5”, type: | | | | | | |
| | “church”, | | | | | | |
| | detailed_{—} | | | | | | |
| | description: | | | | | | |
| | “ “, | | | | | | |
| | . . . } | | | | | | |
| #2 | (popularity: | 0% | 30 | 120 | −5 | 41.002 | −73.401 |
| 1414 | “4.0”, | | | | | | |
| | knowledge: | | | | | | |
| | “0”, type: | | | | | | |
| | “shopping | | | | | | |
| | mall”, | | | | | | |
| | detailed_{—} | | | | | | |
| | description: | | | | | | |
| | “ “, | | | | | | |
| | . . . } | | | | | | |

In this scenario, the ranking module 145b is configured to select object #2 1414 as the most helpful object to the user in the current field of view (e.g., high-rank POI) despite the fact that object #2 1414 is not in the user's current field of view 1410. In this scenario, the high-rank POI is determined by distance rather than visibility to the user in the current field of view 1410.

In FIG. 14B, to further explain the determination of the priority of each candidate PoI from the list of candidate PoIs 1422, 1424, in an exemplary scenario depicted in Table-4 and visualized using Map 1400. Table-4 presents the details of various objects in a tabular format, providing information such as object ID and additional relevant attributes. In an embodiment, the map 1401 is utilized to visually represent the objects.

TABLE 4
Input

| object_{—} | | visible_{—} | | horizontal_{—} | vertical_{—} | | |
|---|---|---|---|---|---|---|---|
| id | description | area_% | distance | angle | angle | latitude | longitude |
| #1 | {popularity: | 50% | 60 | 50 | 10 | 41.121 | −73.112 |
| 1422 | “5”, | | | | | | |
| | knowledge: | | | | | | |
| | “3”, type: | | | | | | |
| | “monument”, | | | | | | |
| | name: “Taj | | | | | | |
| | Mahal”, | | | | | | |
| | detailed_{—} | | | | | | |
| | description: | | | | | | |
| | “ “, | | | | | | |
| | . . . } | | | | | | |
| #2 | {popularity: | 0% | 30 | 120 | −5 | 41.002 | −73.401 |
| 1424 | “3.5”, | | | | | | |
| | knowledge: | | | | | | |
| | “0”, type: | | | | | | |
| | “shopping | | | | | | |
| | mall”, name: | | | | | | |
| | “ABC Mall”, | | | | | | |
| | detailed_{—} | | | | | | |
| | description: | | | | | | |
| | “ “, | | | | | | |
| | . . . } | | | | | | |

In this scenario, the ranking module 145b is configured to select object #1 1422 as the most helpful object to the user in the current field of view 1420 (e.g., high-rank POI) despite the fact that object #1 1422 has more distance (e.g., 60) from the user. In this scenario, the high-rank POI is determined by popularity rather than the distance.

FIG. 15 illustrates a block diagram of the digital assistant engine 146 associated with the voice-based navigation module 140, according to an embodiment of the disclosure.

The digital assistant engine 146 includes a command reception module 146a and a dialogue management module 146b, wherein the dialogue management module 146b includes a natural language generator 146b1 and a text-to-speech (TTS) engine 146b2.

The command reception module 146a is configured to create structured navigation instruction data that incorporates relevant information associated with each candidate PoI, as described in conjunction with FIG. 16A-16B. The command reception module 146a may consider various factors such as the current location of the user, direction, and other contextual details to generate accurate instructions. For example, phrases like “turn left”, “turn right”, “turn back”, “look left”, “look right”, “look up”, and “look down” may be utilized as part of the generated navigation instructions.

The natural language generator 146b1 is configured to transform the structured navigation instruction data into natural language text, which may be easily understood by the user as described in conjunction with FIG. 17. This transformation process can be accomplished using either a machine learning model or a rule-based model. By leveraging these models, the natural language generator 146b1 may ensure that the transformed natural language text is clear, concise, and contextually appropriate.

Once the navigation instruction text is transformed, the TTS engine 146b2 is configured to convert the transformed natural language text into spoken words, providing an audible form of the navigation instructions to the user, as described in conjunction with FIG. 18 and FIG. 19. This conversion process typically involves several operations, including text analysis, phoneme generation, prosody modeling, signal processing, and voice synthesis. These modules (e.g., 146a and 146b) collectively ensure that the spoken instructions are delivered in a natural and intelligible manner, enabling the user to comprehend and follow navigation guidance effectively.

FIGS. 16A and 16B illustrate various operations of the command reception module 146a associated with the digital assistant engine 146, according to an embodiment of the disclosure. FIG. 16A is a flow diagram illustrating a method 1600 for creating the structured navigation instruction data that incorporates relevant information associated with each candidate PoI.

At operation 1601, the method 1600 includes receiving the list of POIs with the information, where the information of POI contains description, distance, horizontal angle, and vertical angle.

At operations 1602 and 1603, the method 1600 includes utilizing one or more processors to create the structured navigation instruction data that incorporates relevant information associated with each candidate PoI, as described in conjunction with FIG. 16B. The one or more processors may include, for example, a description processor, a distance processor, a horizontal angle processor, and a vertical angle processor.

In FIG. 16B, in operations 1610 to 1614 of the disclosed method, the one or more processors 1602 are configured to perform various functionalities. At operation 1610, the one or more processors 1602 is configured to receive the list of POIs along with their information from the PoI estimation engine 145. At operation 1611, the one or more processors 1602 is configured to perform the POS tagging on the received list of POIs. This involves labeling words as nouns, verbs, adjectives, and other parts of speech. The one or more processors 1602 is configured to utilize libraries such as the natural language processing techniques toolkit (NLTK) or SpaCy to carry out the POS tagging. At operation 1612, the one or more processors 1602 is configured to perform a word selection process based on the POS tagging results. This process involves selecting relevant words for further analysis and classification. At operations 1613 and 1614, the one or more processors 1602 are configured to classify the adjectives and verbs identified in the previous operations. This classification helps in creating structured navigation instruction data, allowing for organized and meaningful instructions related to the POIs.

To further explain functionalities of the one or more processors 1602, in an exemplary scenario depicted in Table-5 and Table-6. Table-5 presents the details of various attributes in a tabular format to create the structured navigation instruction data by utilizing the description processor. Similarly, Table-6 presents the details of various attributes in a tabular format to create the structured navigation instruction data by utilizing the distance processor.

TABLE 5

| | | | Adjective and | Output |
|---|---|---|---|---|
| | | Words | word | structured |
| Info of POI | POS tagging | selector | classification | data |
| “TINTIN pastry shop | “TINTIN”: | “TINTIN | “famous”: | Entity: |
| is famous for velvet | proper noun, | pastry shop”: | reputation of | “TINTIN |
| cake.” | “pastry”: | proper noun | object, | pastry shop”, |
| | noun, “shop”: | phrase, | “velvet”: type | Attribute 1: |
| | noun, “is”: | “velvet cake”: | of cake | “Famous”, |
| | verb, | noun phrase | | Attribute 2: |
| | “famous”: | | | “Cake type: |
| | adjective, | | | velvet” |
| | “for”: | | | |
| | proposition, | | | |
| | “velvet”: | | | |
| | adjective, | | | |
| | “cake”: noun | | | |

TABLE 6

| | | | Adjective and | Output |
|---|---|---|---|---|
| | | Words | word | structured |
| Info of POI | POS tagging | selector | classification | data |
| “distance 25 meter” | “distance”: | “25 meter”: | none | Attribute: |
| | noun, “25”: | noun phrase | | “distance”, |
| | numeral, | | | Value: “25”, |
| | “meter”: noun | | | Unit: “meter” |

FIG. 17 is a flow diagram illustrating a method 1700 for generating the navigation instruction, according to an embodiment of the disclosure. The natural language generator 146b1 is configured to create a set of templates for the structured navigation instruction data involves identifying common scenarios and possible instructions and specifying the templates that can generate the navigation instruction. In an embodiment, the natural language generator 146b1 is configured to execute multiple operations to generate the navigation instruction, which are given below.

At operation 1701, the method 1700 includes receiving the structured navigation instruction data from the command reception module 146a. At operation 1702, the method 1700 includes determining the appropriate template to use for generating the navigation instruction. At operation 1703, the method 1700 includes identifying the relevant data elements from the structured navigation instruction data that are needed to populate the template. The template requires one or more values, which are fetched from the structured navigation instruction data. For example, if the template specifies a distance parameter, the natural language generator 146b1 is configured to fetch the corresponding distance value from the structured navigation instruction data. At operation 1704, the method 1700 includes utilizing the fetched data to populate the template. The natural language generator 146b1 is configured to place the fetched values into the template to create a complete navigation instruction. At operation 1705, the method 1700 includes applying grammar and language rules to the complete navigation instruction. This ensures that the instruction adheres to proper grammar and language conventions.

Finally, at operation 1706, the method 1700 includes generating the final navigation instruction based on the applied grammar and language rules. This instruction provides clear and coherent guidance for navigation. For example, if the structured navigation instruction data includes a template that requires the distance value to be inserted, the method 1700 fetches the distance value from the data and populates the template. The resulting instruction could be “turn left in 500 meters”. The grammar and language rules are then applied to ensure the instruction is correctly formatted, and the final navigation instruction is generated as “In 500 meters, make a left turn”.

In one or more embodiments, the method 1700 utilizes templates to generate navigation instructions based on structured data. In an exemplary scenario, the following example templates:
a. Template 1: “Your destination “<destination_name>” is on the <direction_from_user> of you and next to <POI_name_before_destination>.”
b. Template 2: “Your destination “<destination_name>” is in <direction_from_user> side of you and just after the <POI_name_before_destination>.”
c. Template 3: “You see <visible_POI_name_in_front_of_user>. Look in <direction_of_destination_from_visible_POI_name_in_front_of_user> of it. After <POI_name_before_destination>, there is your destination.”

Let's consider the following structured data:
a. “Destination_name”: “sky shop”
b. “Direction_from_user”: “right”
c. “POI_name_before_destination”: “TINTIN pastry shop”

Based on the provided structured data, the matching templates are a and b. These templates can be populated as follows:
a. Template 1: “Your destination “sky shop” is on the right of you and next to TINTIN Pastry shop.”
b. Template 2: “Your destination “sky shop” is in the right side of you and just after the TINTIN Pastry shop.”

Either of the above instructions can be provided as input to the TTS engine 146b2 for generating audible navigation instructions to guide the user, as described in conjunction with FIG. 18 and FIG. 19.

FIG. 18 is a flow diagram illustrating a method 1800 for providing training to the TTS engine 146b2 associated with the digital assistant engine 146, according to an embodiment of the disclosure.

At operation 1801, the method 1800 includes receiving preprocessed speech data, which represents the navigation instruction. At operation 1802, the method 1800 includes extracting one or more features from the preprocessed speech data. These features can include phonemes (e.g., distinct speech sounds), Mel-Frequency Cepstral Coefficients (MFCCs) (e.g., acoustic features), prosodic features like pitch, energy, stress rhythm, and duration, as well as linguistic features that provide information about phonemes, syllables, words, and phrases in the text, along with the grammatical structure and context. At operation 1803, the method 1800 includes training the TTS engine 146b2 using one or more models, such as a Recurrent Neural Network (RNN) or a Convolutional Neural Network (CNN). During the training process, the models learn to map the linguistic features to the appropriate acoustic features, such as the fundamental frequency, amplitude, spectral envelope, and duration.

FIG. 19 is a flow diagram illustrating a method 1900 for generating a modified output audio for the voice-based navigation, according to an embodiment of the disclosure.

At operation 1901, the method 1900 includes receiving the generated navigation instruction, which is the input text produced by the natural language generator 146b1. At operation 1902, the method 1900 includes extracting one or more features from the generated navigation instruction. These features capture the linguistic properties of the input text, such as parts of speech, sentence structure, and semantic meaning. The extracted linguistic features are used to generate a phonetic transcription, representing the pronunciation of the words in the input text. At operation 1903, the method 1900 includes the extracted features to the trained TTS engine 146b2, which relates to FIG. 18, which is capable of transforming linguistic features into acoustic features. At operation 1904, the method 1900 includes synthesizing speech and performing post-processing on the audio. This includes converting the acoustic features, represented as a spectrogram or other acoustic representation, into an audio waveform using a vocoder. The post-processing operations may be applied, such as noise removal, volume adjustment, or other audio effects. Finally, at operation 1905, the method 1900 includes generating the output audio, representing the synthesized speech based on the given input text.

In one embodiment, the disclosed method (e.g., 1800 and 1900) involves the creation and training of the TTS engine 146b2, similar to WaveNet or Tacotron. The TTS engine 146b2 is trained using a large dataset of navigation instructions and their respective audio recordings. For example, navigation instructions like “your destination ‘sky shop’ is on the right of you and next to TINTIN pastry shop” or “your destination “sky shop” is in right side of you and just after the TINTIN pastry shop” or “you see H bank. Look in right of it. After ATM, there is your destination” are used in the training process.

After the TTS engine 146b2 is trained, the TTS engine 146b2 can be utilized for converting text instructions into speech. For instance, if a new instruction such as “your destination “R shop” is in the back side of you and just after the ATM” is provided, the trained model will generate a spectrogram representing the speech. The spectrogram of the speech output can be passed to the vocoder, such as the WaveNet vocoder, to convert it into a playable audio waveform. The resulting audio can then be played through the speaker 147, allowing the user to hear the synthesized speech corresponding to the given instruction.

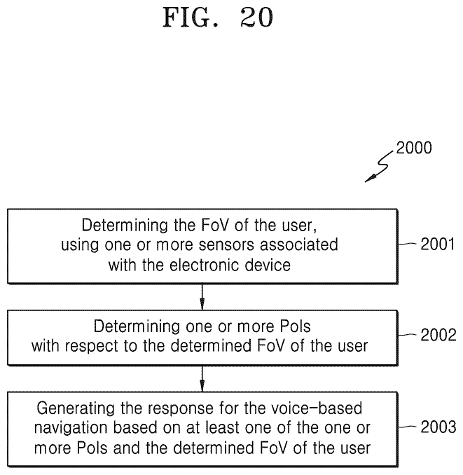

FIG. 20 is a flow diagram illustrating a method 2000 for the voice-based navigation, according to an embodiment of the disclosure.

At operation 2001, the method 2000 includes determining the current FoV of the user, using one or more sensors associated with the electronic device 100. At operation 2002, the method 2000 includes determining the one or more optimal PoIs with respect to the determined current FoV of the user. At operation 2003, the method 2000 includes generating the response for the voice-based navigation based on at least one of the one or more optimal PoIs and the determined current FoV of the user.

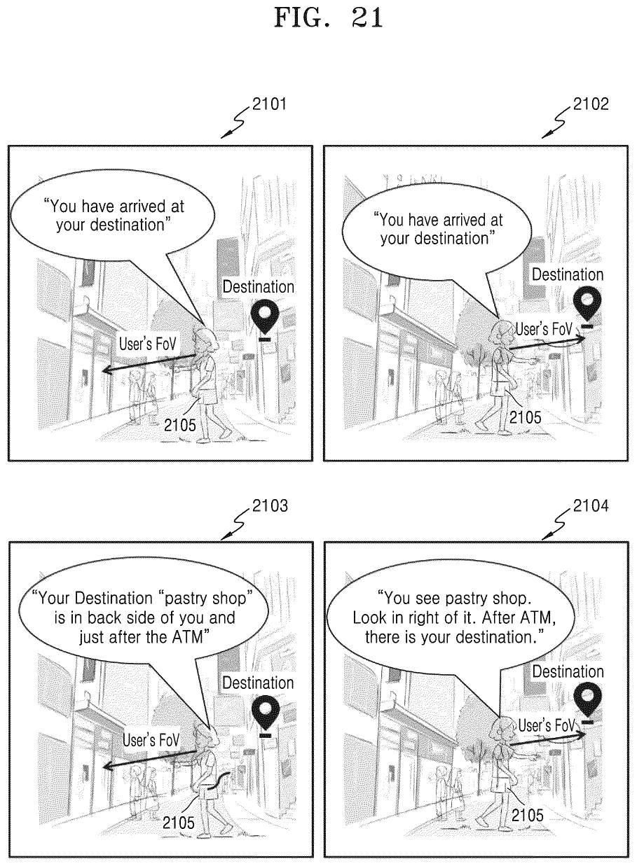

FIG. 21 illustrates an exemplary comparison between the conventional voice-based navigation method (e.g. 2101 and 2102) and the disclosed voice-based navigation method (e.g. 2103 and 2104), according to an embodiment of the disclosure.

In the conventional voice-based navigation method (e.g. 2101 and 2102), where a user 2105 is walking in a city and utilizing an electronic device with voice-based navigation capabilities, certain limitations exist such as the conventional voice-based navigation method (e.g. 2101 and 2102) primarily relies on earbuds or headphones for providing audible directions, neglecting the potential of the electronic device's built-in sensors. These sensors, such as GPS and other environmental sensors, are not optimally utilized to enhance the accuracy of navigation. Additionally, the conventional voice-based navigation method (e.g. 2101 and 2102) heavily depends on visual map displays, necessitating the user 2105 to continuously monitor the electronic device's screen for map information and nearby PoIs. This detracts from the user experience as it requires constant visual attention and can be distracting while walking. Additionally, in the conventional voice-based navigation method (e.g. 2101 and 2102), when the user reaches the vicinity of their destination, the response is often a simple message like “You have arrived at your destination.” This limited response may not provide sufficient information to help the user 2105 to locate the precise destination point, forcing them to rely on additional device features such as photos or maps, which can be cumbersome and detract from the user experience.

For example, the user is using an electronic device with voice-based navigation to find a pastry shop in the city. In the conventional voice-based navigation methods (e.g. 2101 and 2102), the user 2105 relies on earbuds for audible directions and must frequently check the visual map display for guidance. When the user 2105 reaches the general area of the pastry shop, the conventional voice-based navigation method (e.g. 2101 and 2102) simply notifies them of arrival without specifying the exact location. As a result, the user 2105 may struggle to locate the specific pastry shop and need to consult photos or maps on the electronic device. This diminishes the overall user experience and adds complexity to the voice-based navigation.

Now, the disclosed voice-based navigation method (e.g. 2103 and 2104) addresses these limitations by leveraging the inherent sensors of the electronic device 100, one or more technical advantages, minimizing reliance on visual map displays, and providing more detailed and accurate voice guidance. For example, the user is using the electronic device 100 with voice-based navigation to find the pastry shop in the city. When the user 2105 reaches the general area of the pastry shop, the disclosed voice-based navigation method (e.g. 2103 and 2104) provides the modified response such as “Your Destination “pastry shop” is in back side of you and just after the ATM”, “You see pastry shop. Look in right of it. After ATM, there is your destination”, or alike. As a result, the user experience is improved during the voice-based navigation.

The various actions, acts, blocks, operations, or the like in the flow diagrams may be performed in the order presented, in a different order, or simultaneously. Further, in some embodiments, some of the actions, acts, blocks, operations, or the like may be omitted, added, modified, skipped, or the like without departing from the scope of the invention.

Unless otherwise defined, all technical and scientific terms used herein have the same meaning as commonly understood by one ordinary skilled in the art to which this invention belongs. The system, methods, and examples provided herein are illustrative only and not intended to be limiting.

While specific language has been used to describe the present subject matter, any limitations arising on account thereto, are not intended. As would be apparent to a person in the art, various working modifications may be made to the method to implement the inventive concept as taught herein. The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment.

The embodiments disclosed herein can be implemented using at least one hardware device and performing network management functions to control the elements.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

According to an embodiment of the disclosure, a method performed by the electronic device for voice-based navigation may include determining at least one of a roll angle, a pitch angle, and a yaw angle associated with a head orientation of the user, using the one or more sensors. According to an embodiment of the disclosure, a method performed by the electronic device for voice-based navigation may include determining a vertical FoV and a horizontal FoV of the user based on the at least one of the roll angle, the pitch angle, and the yaw angle. According to an embodiment of the disclosure, a method performed by the electronic device for voice-based navigation may include determining the FoV of the user based on the determined vertical FoV and the determined horizontal FoV.

According to an embodiment of the disclosure, a method performed by the electronic device for voice-based navigation may include determining a list of candidate PoIs and information associated with each candidate PoI, based on the FoV of the user and a location of the user, wherein the information associated with each candidate PoI comprises at least one of a candidate object identity, a candidate object shape, a candidate object type, a candidate object name, a visible area information, a distance information, an angle information, and a location information. According to an embodiment of the disclosure, a method performed by the electronic device for voice-based navigation may include determining a description of each candidate PoI from the list of candidate PoIs, based on at least one of a spatial context information associated with each candidate PoI, a category information associated with each candidate PoI, and a review information associated with each candidate PoI. According to an embodiment of the disclosure, a method performed by the electronic device for voice-based navigation may include determining a priority of each candidate PoI from the list of candidate PoIs, based on the determined description and one or more ranking parameters.

According to an embodiment of the disclosure, a method performed by the electronic device for voice-based navigation may include determining the one or more PoIs based on the determined priority. According to an embodiment of the disclosure, a method performed by the electronic device for voice-based navigation may include receiving the list of candidate PoIs, wherein a destination point is associated with at least one candidate PoI from the list of candidate PoIs. According to an embodiment of the disclosure, a method performed by the electronic device for voice-based navigation may include ranking, based on the angle information, the list of candidate PoIs in a case that the destination point belongs to the one or more visible areas. According to an embodiment of the disclosure, a method performed by the electronic device for voice-based navigation may include ranking, based on the angle information, the list of candidate PoIs in cases that the destination point does not belong to the one or more visible areas, the destination point does not belong to a front side of the user, and the destination point belongs to the one or more visible areas based on identifying that the user turns towards a destination angle.

According to an embodiment of the disclosure, a method performed by the electronic device for voice-based navigation may include ranking the list of candidate PoIs based on the distance information, the visible area information, and the angle information in a case that the destination point does not belong to the one or more visible areas and the destination point belongs to the front side of the user. According to an embodiment of the disclosure, a method performed by the electronic device for voice-based navigation may include ranking the list of candidate PoIs based on the distance information, the visible area information, and the angle information in cases that the destination point does not belong to the one or more visible areas, the destination point does not belong to the front side of the user, and the destination point does not belong to the one or more visible areas based on identifying that the user turns towards the destination angle.

According to an embodiment of the disclosure, a method performed by the electronic device for voice-based navigation may include generating a customized digital elevation model (DEM) of the location of the user. According to an embodiment of the disclosure, a method performed by the electronic device for voice-based navigation may include determining one or more visible areas and one or more non-visible areas associated with the generated customized DEM in relation to the location of the user. According to an embodiment of the disclosure, a method performed by the electronic device for voice-based navigation may include determining the list of candidate PoIs and the information associated with each candidate PoI based on at least one of the generated customized DEM, the determined one or more visible areas, the determined one or more non-visible areas, and one or more object recognition mechanisms.

According to an embodiment of the disclosure, a method performed by the electronic device for voice-based navigation may include acquiring elevation data, associated with the location and the FoV of the user. According to an embodiment of the disclosure, a method performed by the electronic device for voice-based navigation may include applying at least one image processing mechanism to enhance the acquired elevation data. According to an embodiment of the disclosure, a method performed by the electronic device for voice-based navigation may include combining the enhanced elevation data with relevant data associated with the location of the user, wherein the relevant data is associated with predefined information of a map associated with the location.

According to an embodiment of the disclosure, a method performed by the electronic device for voice-based navigation may include generating the customized DEM based on a combination of the enhanced elevation data and the relevant data, wherein the generated customized DEM comprises a low-level elevation information and characteristics of physical features.

According to an embodiment of the disclosure, the one or more visible areas and the one or more non-visible areas may be determined by using the generated customized DEM and user-information, wherein the user-information comprises at least one of the location of the user, a height, a roll angle, a pitch angle, a yaw angle, a vertical FoV, and a horizontal FoV.

According to an embodiment of the disclosure, a method performed by the electronic device for voice-based navigation may include generating one or more structured navigation instruction data for information associated with each candidate PoI. According to an embodiment of the disclosure, a method performed by the electronic device for voice-based navigation may include generating one or more navigation instruction texts from the one or more generated structured navigation instructions. According to an embodiment of the disclosure, a method performed by the electronic device for voice-based navigation may include converting the generated one or more navigation instruction texts into navigation instruction audio to generate the response for the voice-based navigation.

According to an embodiment of the disclosure, a method performed by the electronic device for voice-based navigation may include performing a part of speech (POS) tagging for the information associated with each candidate PoI, wherein the POS tagging indicates at least one of a noun information, a verb information, and an adjective information. According to an embodiment of the disclosure, a method performed by the electronic device for voice-based navigation may include determining a list of words from the POS tagging. According to an embodiment of the disclosure, a method performed by the electronic device for voice-based navigation may include generating the one or more structured navigation instruction data based on the determined list of words.

According to an embodiment of the disclosure, a method performed by the electronic device for voice-based navigation may include determining one or more templates, from a pre-defined set of templates, for the generated one or more structured navigation instruction data. According to an embodiment of the disclosure, a method performed by the electronic device for voice-based navigation may include determining relevant data elements from the generated one or more structured navigation instruction data as per a requirement of the one or more determined templates. According to an embodiment of the disclosure, a method performed by the electronic device for voice-based navigation may include inserting the determined relevant data elements into the one or more determined templates. According to an embodiment of the disclosure, a method performed by the electronic device for voice-based navigation may include applying grammar and language rules on the one or more determined templates to generate the one or more navigation instruction texts.

According to an embodiment of the disclosure, a method performed by the electronic device for voice-based navigation may include extracting one or more features from the generated one or more navigation instruction texts, wherein the one or more features comprises at least one of a common feature, a prosodic feature, and a linguistic feature. According to an embodiment of the disclosure, a method performed by the electronic device for voice-based navigation may include passing the one or more extracted features to at least one trained text-to-speech (TTS) model, wherein the at least one trained TTS model is configured to map the linguistic feature into an appropriate acoustic feature. According to an embodiment of the disclosure, a method performed by the electronic device for voice-based navigation may include generating, by the at least one trained TTS model, an acoustic representation associated with the appropriate acoustic feature. According to an embodiment of the disclosure, a method performed by the electronic device for voice-based navigation may include converting, by using a vocoder, the generated acoustic representation into a navigation instruction audio.

According to an embodiment of the disclosure, the voice-based navigation module is configured to determine at least one of a roll angle, a pitch angle, and a yaw angle associated with a head orientation of the user, using the one or more sensors. According to an embodiment of the disclosure, the voice-based navigation module is configured to determine a vertical FoV and a horizontal FoV of the user based on the at least one of the roll angle, the pitch angle, and the yaw angle. According to an embodiment of the disclosure, the voice-based navigation module is configured to determine the FoV of the user based on the determined vertical FoV and the determined horizontal FoV.

According to an embodiment of the disclosure, the voice-based navigation module is configured to determine a list of candidate PoIs and information associated with each candidate PoI, based on the FoV of the user and a location of the user, wherein the information associated with each candidate PoI comprises at least one of a candidate object identity, a candidate object shape, a candidate object type, a candidate object name, a visible area information, a distance information, an angle information, and a location information.

According to an embodiment of the disclosure, the voice-based navigation module is configured to determine a description of each candidate PoI from the list of candidate PoIs based on at least one of a spatial context information associated with each candidate PoI, a category information associated with each candidate PoI, and a review information associated with each candidate PoI. According to an embodiment of the disclosure, the voice-based navigation module is configured to determine a priority of each candidate PoI from the list of candidate PoIs based on the determined description and one or more ranking parameters. According to an embodiment of the disclosure, the voice-based navigation module is configured to determine the one or more PoIs based on the determined priority.

According to an embodiment of the disclosure, the voice-based navigation module is configured to receive the list of candidate PoIs, wherein a destination point is associated with at least one candidate PoI from the list of candidate PoIs. According to an embodiment of the disclosure, the voice-based navigation module is configured to rank, based on the angle information, the list of candidate PoIs in a case that the destination point belongs to the one or more visible areas. According to an embodiment of the disclosure, the voice-based navigation module is configured to rank, based on the angle information, the list of candidate PoIs in cases that the destination point does not belong to the one or more visible areas, the destination point does not belong to a front side of the user, and the destination point belongs to the one or more visible areas based on identifying that the user turns towards a destination angle. According to an embodiment of the disclosure, the voice-based navigation module is configured to rank the list of candidate PoIs based on the distance information, the visible area information, and the angle information in a case that the destination point does not belong to the one or more visible areas and the destination point belongs to the front side of the user.

According to an embodiment of the disclosure, the voice-based navigation module is configured to rank the list of candidate PoIs based on the distance information, the visible area information, and the angle information in cases that the destination point does not belong to the one or more visible areas, the destination point does not belong to the front side of the user, and the destination point does not belong to the one or more visible areas based on identifying that the user turns towards the destination angle.

According to an embodiment of the disclosure, the voice-based navigation module is configured to generate a customized digital elevation model (DEM) of the location of the user.

According to an embodiment of the disclosure, the voice-based navigation module is configured to determine one or more visible areas and one or more non-visible areas associated with the generated customized DEM in relation to the location of the user. According to an embodiment of the disclosure, the voice-based navigation module is configured to determine the list of candidate PoIs and the information associated with each candidate PoI based on at least one of the generated customized DEM, the determined one or more visible areas, the determined one or more non-visible areas, and one or more object recognition mechanisms.

According to an embodiment of the disclosure, the voice-based navigation module is configured to acquire elevation data, associated with the location and the FoV of the user. According to an embodiment of the disclosure, the voice-based navigation module is configured to apply at least one image processing mechanism to enhance the acquired elevation data. According to an embodiment of the disclosure, the voice-based navigation module is configured to combine the enhanced elevation data with relevant data associated with the location of the user, wherein the relevant data is associated with predefined information of a map associated with the location.

According to an embodiment of the disclosure, the voice-based navigation module is configured to generate the customized DEM based on a combination of the enhanced elevation data and the relevant data, wherein the generated customized DEM comprises a low-level elevation information and characteristics of physical features.

According to an embodiment of the disclosure, the voice-based navigation module is configured to generate one or more structured navigation instruction data for information associated with each candidate PoI. According to an embodiment of the disclosure, the voice-based navigation module is configured to generate one or more navigation instruction texts from the one or more generated structured navigation instructions. According to an embodiment of the disclosure, the voice-based navigation module is configured to convert the generated one or more navigation instruction texts into navigation instruction audio to generate the response for the voice-based navigation.

According to an embodiment of the disclosure, the voice-based navigation module is configured to perform a part of speech (POS) tagging for the information associated with each candidate PoI, wherein the POS tagging indicates at least one of a noun information, a verb information, and an adjective information. According to an embodiment of the disclosure, the voice-based navigation module is configured to determine a list of words from the POS tagging. According to an embodiment of the disclosure, the voice-based navigation module is configured to generate the one or more structured navigation instruction data based on the determined list of words.

According to an embodiment of the disclosure, the voice-based navigation module is configured to determine one or more templates, from a pre-defined set of templates, for the generated one or more structured navigation instruction data. According to an embodiment of the disclosure, the voice-based navigation module is configured to determine relevant data elements from the generated one or more structured navigation instruction data as per a requirement of the one or more determined templates. According to an embodiment of the disclosure, the voice-based navigation module is configured to insert the determined relevant data elements into the one or more determined templates. According to an embodiment of the disclosure, the voice-based navigation module is configured to apply grammar and language rules on the one or more determined templates to generate the one or more navigation instruction texts.

According to an embodiment of the disclosure, the voice-based navigation module is configured to extract one or more features from the generated one or more navigation instruction texts, wherein the one or more features comprises at least one of a common feature, a prosodic feature, and a linguistic feature. According to an embodiment of the disclosure, the voice-based navigation module is configured to pass the one or more extracted features to at least one trained text-to-speech (TTS) model, wherein the at least one trained TTS model is configured to map the linguistic feature into an appropriate acoustic feature. According to an embodiment of the disclosure, the voice-based navigation module is configured to generate, by the at least one trained TTS model, an acoustic representation associated with the appropriate acoustic feature. According to an embodiment of the disclosure, the voice-based navigation module is configured to convert, by using a vocoder, the generated acoustic representation into a navigation instruction audio.

What is claimed is:

1. A method performed by an electronic device for voice-based navigation, the method comprising:
determining a field of view (FoV) of the user using one or more sensors associated with the electronic device;
determining one or more points of interest (PoIs) with respect to the determined FoV of the user; and
generating a response for the voice-based navigation based on at least one of the one or more PoIs and the determined FoV of the user.

2. The method of claim 1, wherein the determining the FoV of the user using the one or more sensors comprises:
determining at least one of a roll angle, a pitch angle, and a yaw angle associated with a head orientation of the user, using the one or more sensors;
determining a vertical FoV and a horizontal FoV of the user based on the at least one of the roll angle, the pitch angle, and the yaw angle; and
determining the FoV of the user based on the determined vertical FoV and the determined horizontal FoV.

3. The method of claim 1, wherein the determining the one or more optimal PoIs comprises:
determining a list of candidate PoIs and information associated with each candidate PoI, based on the FoV of the user and a location of the user, wherein the information associated with each candidate PoI comprises at least one of a candidate object identity, a candidate object information, an angle information, and a location information;
determining a description of each candidate PoI from the list of candidate PoIs, based on at least one of a spatial context information associated with each candidate PoI, a category information associated with each candidate PoI, and a review information associated with each candidate PoI;
determining a priority of each candidate PoI from the list of candidate PoIs, based on the determined description and one or more ranking parameters; and
determining the one or more PoIs based on the determined priority.

4. The method of claim 3, wherein the determining the priority of each candidate PoI from the list of candidate PoIs based on the determined description comprises:
receiving the list of candidate PoIs, wherein a destination point is associated with at least one candidate PoI from the list of candidate PoIs; and
performing at least one of:
ranking, based on the angle information, the list of candidate PoIs in a case that the destination point belongs to the one or more visible areas;
ranking, based on the angle information, the list of candidate PoIs in cases that:
the destination point does not belong to the one or more visible areas,
the destination point does not belong to a front side of the user, and
the destination point belongs to the one or more visible areas based on identifying that the user turns towards a destination angle;
ranking the list of candidate PoIs based on the distance information, the visible area information, and the angle information in a case that the destination point does not belong to the one or more visible areas and the destination point belongs to the front side of the user; and
ranking the list of candidate PoIs based on the distance information, the visible area information, and the angle information in cases that:
the destination point does not belong to the one or more visible areas,
the destination point does not belong to the front side of the user, and
the destination point does not belong to the one or more visible areas based on identifying that the user turns towards the destination angle.

5. The method of claim 3, wherein the determining the list of candidate PoIs and the information associated with each candidate PoI comprises:
generating a customized digital elevation model (DEM) of the location of the user;
determining one or more visible areas and one or more non-visible areas associated with the generated customized DEM in relation to the location of the user; and
determining the list of candidate PoIs and the information associated with each candidate PoI based on at least one of the generated customized DEM, the determined one or more visible areas, the determined one or more non-visible areas, and one or more object recognition mechanisms.

6. The method of claim 5, wherein the generating the customized DEM comprises:
acquiring elevation data, associated with the location and the FoV of the user;
applying at least one image processing mechanism to enhance the acquired elevation data;
combining the enhanced elevation data with relevant data associated with the location of the user, wherein the relevant data is associated with predefined information of a map associated with the location; and
generating the customized DEM based on a combination of the enhanced elevation data and the relevant data, wherein the generated customized DEM comprises a low-level elevation information and characteristics of physical features.

7. The method of claim 5, wherein the one or more visible areas and the one or more non-visible areas are determined by using the generated customized DEM and user-information, wherein the user-information comprises at least one of the location of the user, a height, a roll angle, a pitch angle, a yaw angle, a vertical FoV, and a horizontal FoV.

8. The method of claim 1, wherein the generating the response for the voice-based navigation comprises:
generating one or more structured navigation instruction data for information associated with each candidate PoI;
generating one or more navigation instruction texts from the one or more generated structured navigation instructions; and
converting the generated one or more navigation instruction texts into navigation instruction audio to generate the response for the voice-based navigation.

9. The method of claim 8, wherein the generating one or more structured navigation instruction data comprises:
performing a part of speech (POS) tagging for the information associated with each candidate PoI, wherein the POS tagging indicates at least one of a noun information, a verb information, and an adjective information;
determining a list of words from the POS tagging; and
generating the one or more structured navigation instruction data based on the determined list of words.

10. The method of claim 8, wherein generating one or more navigation instruction texts from the generated one or more structured navigation instruction data comprises:
determining one or more templates, from a pre-defined set of templates, for the generated one or more structured navigation instruction data;
determining relevant data elements from the generated one or more structured navigation instruction data as per a requirement of the one or more determined templates;
inserting the determined relevant data elements into the one or more determined templates; and
applying grammar and language rules on the one or more determined templates to generate the one or more navigation instruction texts.

11. An electronic device for voice-based navigation, the electronic device comprising:
a communicator;
a voice-based navigation module;
a memory storing at least one instruction; and
at least one processor operatively connected to the communicator, the voice-based navigation module, and the memory,
wherein the voice-based navigation module is configured to:
determine a field of view (FoV) of the user, using one or more sensors associated with the system;
determine one or more points of interest (PoIs) with respect to the determined FoV of the user; and
generate a response for the voice-based navigation based on at least one of the one or more PoIs and the determined FoV of the user.

12. The electronic device of claim 11, wherein the voice-based navigation module is further configured to:
determine at least one of a roll angle, a pitch angle, and a yaw angle associated with a head orientation of the user, using the one or more sensors;
determine a vertical FoV and a horizontal FoV of the user based on the at least one of the roll angle, the pitch angle, and the yaw angle; and
determine the FoV of the user based on the determined vertical FoV and the determined horizontal FoV.

13. The electronic device of claim 11, wherein the voice-based navigation module is further configured to:
determine a list of candidate PoIs and information associated with each candidate PoI, based on the FoV of the user and a location of the user, wherein the information associated with each candidate PoI comprises at least one of a candidate object identity, a candidate object information, an angle information, and a location information;
determine a description of each candidate PoI from the list of candidate PoIs based on at least one of a spatial context information associated with each candidate PoI, a category information associated with each candidate PoI, and a review information associated with each candidate PoI;
determine a priority of each candidate PoI from the list of candidate PoIs based on the determined description and one or more ranking parameters; and
determine the one or more PoIs based on the determined priority.

14. The electronic device of claim 13, wherein the voice-based navigation module is further configured to:
receive the list of candidate PoIs, wherein a destination point is associated with at least one candidate PoI from the list of candidate PoIs; and
perform at least one of:
ranking, based on the angle information, the list of candidate PoIs in a case that the destination point belongs to the one or more visible areas;
ranking, based on the angle information, the list of candidate PoIs in cases that:
the destination point does not belong to the one or more visible areas,
the destination point does not belong to a front side of the user, and
the destination point belongs to the one or more visible areas based on identifying that the user turns towards a destination angle;
ranking the list of candidate PoIs based on the distance information, the visible area information, and the angle information in a case that the destination point does not belong to the one or more visible areas and the destination point belongs to the front side of the user; and
ranking the list of candidate PoIs based on the distance information, the visible area information, and the angle information in cases that:
the destination point does not belong to the one or more visible areas,
the destination point does not belong to the front side of the user, and
the destination point does not belong to the one or more visible areas based on identifying that the user turns towards the destination angle.

15. The electronic device of claim 13, wherein the voice-based navigation module is further configured to:
generate a customized digital elevation model (DEM) of the location of the user;
determine one or more visible areas and one or more non-visible areas associated with the generated customized DEM in relation to the location of the user; and
determine the list of candidate PoIs and the information associated with each candidate PoI based on at least one of the generated customized DEM, the determined one or more visible areas, the determined one or more non-visible areas, and one or more object recognition mechanisms.

16. The electronic device of claim 15, wherein the voice-based navigation module is further configured to:
acquire elevation data, associated with the location and the FoV of the user;
apply at least one image processing mechanism to enhance the acquired elevation data;
combine the enhanced elevation data with relevant data associated with the location of the user, wherein the relevant data is associated with predefined information of a map associated with the location; and
generate the customized DEM based on a combination of the enhanced elevation data and the relevant data, wherein the generated customized DEM comprises a low-level elevation information and characteristics of physical features.

17. The electronic device of claim 15, wherein the one or more visible areas and the one or more non-visible areas are determined by using the generated customized DEM and user-information, wherein the user-information comprises at least one of the location of the user, a height, a roll angle, a pitch angle, a yaw angle, a vertical FoV, and a horizontal FoV.

18. The electronic device of claim 11, wherein the voice-based navigation module is further configured to:
generate one or more structured navigation instruction data for information associated with each candidate PoI;
generate one or more navigation instruction texts from the one or more generated structured navigation instructions; and
convert the generated one or more navigation instruction texts into navigation instruction audio to generate the response for the voice-based navigation.

19. The electronic device of claim 18, wherein the voice-based navigation module is further configured to:
perform a part of speech (POS) tagging for the information associated with each candidate PoI, wherein the POS tagging indicates at least one of a noun information, a verb information, and an adjective information;
determine a list of words from the POS tagging; and
generate the one or more structured navigation instruction data based on the determined list of words.

20. The electronic device of claim 18, wherein the voice-based navigation module is further configured to:
determine one or more templates, from a pre-defined set of templates, for the generated one or more structured navigation instruction data;
determine relevant data elements from the generated one or more structured navigation instruction data as per a requirement of the one or more determined templates;
insert the determined relevant data elements into the one or more determined templates; and
apply grammar and language rules on the one or more determined templates to generate the one or more navigation instruction texts.
